(19) United States
(12) Patent Application Publication
(10) Pub. No.: US 2026/0253229 A1
(43) Pub. Date: Aug. 27, 2026

(54) DISTILLED UNSUPERVISED DOMAIN ADAPTATION FOR LIGHTWEIGHT SEMANTIC UNDERSTANDING MODELS

(71) Applicant: SRI International, Menlo Park, CA (US)

(72) Inventors: Han-Pang Chiu, West Windsor, NJ (US); Niluthpol Mithun, Dayton, NJ (US); Abhinav Rajvanshi, Pennington, NJ (US); Supun Samarasekera, Skillman, NJ (US); Beomseok Kang, Cheongju-si (KR); Mikhail Sizintsev, Highland Park, NJ (US)

(21) Appl. No.: 19/543,480

(22) Filed: Feb. 18, 2026

Related U.S. Application Data
(60) Provisional application No. 63/764,373, filed on Feb. 27, 2025.
(60) Provisional application No. 63/894,228, filed on Oct. 6, 2025.

(51) Int. Cl. G06T 7/12; G06N 3/0464; G06N 3/09

(52) U.S. Cl. CPC G06T 7/12; G06N 3/0464; G06N 3/09

(57) ABSTRACT

Example embodiments relate to distilled unsupervised domain adaptation for lightweight semantic understanding models. One example embodiment includes a method. The method includes obtaining a source image, a semantic segmentation corresponding to the source image, and a target image. The method also includes obtaining a first source segmentation and a first target segmentation. The method further includes updating a first student model to obtain an updated first student model. Updating the first student model includes determining a first model update value based on the first source segmentation and the semantic segmentation, determining a second model update value based on the first target segmentation and a second target segmentation, and determining updated student weights corresponding to the first student model based on the first model update value and the second model update value. Additionally, the method includes obtaining, using the updated first student model, an updated segmentation.

### CROSS-REFERENCE TO RELATED APPLICATIONS

This application claims priority to U.S. Provisional Patent Application No. 63/764,373, filed on Feb. 27, 2025, and U.S. Provisional Patent Application No. 63/894,228, filed on Oct. 6, 2025, both of which are hereby incorporated by reference in their entirety.

### BACKGROUND

Domain shift is a challenge in vision-related tasks due to variations in sensors and environmental conditions (e.g., weather, lighting) and diverse visual styles across platforms. Domain adaptation approaches may be used to mitigate performance degradation when systems encounter data distributions different from their training sets. Unsupervised domain adaptation (UDA) may be one such approach and may address these issues, such as within the domain of semantic segmentation, because it may reduce the need for costly labeled target data (e.g., pixel-wise annotation). UDA semantic segmentation techniques may be based on self-training, where both the student model and teacher model may share identical architecture and undergo interactive optimization. However, this may not adequately balance accuracy with efficiency, which may cause a failure to deliver robust performance under limited computation budgets, such as during real-time use in autonomous driving and/or mobile robotics.

In related scenarios, multi-task dense prediction may aim to jointly solve multiple pixel-level vision problems, such as semantic segmentation and depth estimation. For example, semantic segmentation may provide categorical understanding of each pixel, while depth estimation may recover geometric structure. Learning these tasks within a single model may enable richer and more reliable scene representations. It also may improve computational efficiency by sharing at least a portion of the model architecture across tasks, which may be critical under limited computation budgets, such as mobile robotics and/or autonomous driving. However, supervised multi-task learning may be challenging. For example, generating pixel-wise labels may require costly and time-consuming manual annotation (e.g., to generate segmentation labels) and/or specialized devices such as multi-view stereo cameras (e.g., to generate depth labels).

### SUMMARY

In a first aspect, a method is provided. The method includes obtaining a source image, a semantic segmentation corresponding to the source image, and a target image. The method also includes obtaining, using a first student model and based on the source image, a first source segmentation. Further, the method includes obtaining, using the first student model and based on the target image, a first target segmentation. Moreover, the method includes updating the first student model to obtain an updated first student model. The updating of the first student model includes determining a first model update value based on the first source segmentation and the semantic segmentation. The updating also includes determining a second model update value based on the first target segmentation and a second target segmentation. The second target segmentation is based on the target image and is obtained using a first teacher model. The updating also includes determining updated student weights corresponding to the first student model based on the first model update value and the second model update value. Additionally, the method includes obtaining, using the updated first student model, an updated segmentation based on the source image or the target image.

In a second aspect, a method is provided. The method includes obtaining a source image, a semantic segmentation corresponding to the source image, and a target image. The method also includes obtaining, using a student model and based on the source image, a student segmentation. Further, the method includes obtaining, using the student model and based on the target image, a student depth. Moreover, the method includes obtaining, using a teacher model and based on the target image, a teacher segmentation. In addition, the method includes updating the student model to obtain an updated student model. Updating the student model includes determining a first student update value based on the student segmentation and the semantic segmentation. The updating also includes determining a second student update value based on the student segmentation and the teacher segmentation. The updating further includes determining updated student model weights corresponding to the student model based on the first student update value and the second student update value. Additionally, the method includes obtaining, using the updated student model, an updated segmentation or an updated depth based on the source image or the target image.

In a third aspect, a non-transitory computer-readable medium is provided. The non-transitory computer-readable medium has stored thereon program instructions that, upon execution by one or more processors of a computing device, cause the computing device to carry out operations. The operations include obtaining a source image, a semantic segmentation corresponding to the source image, and a target image. The operations also include obtaining, using a first student model and based on the source image, a first source segmentation. Further, the operations include obtaining, using the first student model and based on the target image, a first target segmentation. Moreover, the operations include updating the first student model to obtain an updated first student model. Updating the first student model includes determining a first model update value based on the first source segmentation and the semantic segmentation. The updating also includes determining a second model update value based on the first target segmentation and a second target segmentation. The second target segmentation is based on the target image and is obtained using a first teacher model. The updating further includes determining updated student weights based on the first model update value and the second model update value. Additionally, the operations include obtaining, using the updated first student model, an updated segmentation based on the source image or the target image.

In a fourth aspect, the disclosure describes a non-transitory computer-readable medium, having stored thereon program instructions that, when executed by a processor, cause the processor to perform operations disclosed in the aspects described above.

In a fifth aspect, the disclosure describes a system including a processor and a data storage in communication with the processor. The data storage stores program instructions that, when executed by the processor, cause the system to perform operations of the aspects described above.

In a sixth aspect, the disclosure describes a system. The system includes various means for carrying out each of the operations of the aspects described above.

In a seventh aspect, a system may include a processor configured to perform the operations of the aspects described above.

In an eighth aspect, a computer program product may be configured to carry out the operations of the aspects described above.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 depicts a system, in accordance with example embodiments.

FIG. 2 depicts a table of accuracy and inference costs, in accordance with example embodiments.

FIG. 3 depicts a comparison table, in accordance with example embodiments.

FIG. 4 depicts a comparison table, in accordance with example embodiments.

FIG. 5 depicts a table of ablation studies, in accordance with example embodiments.

FIG. 6 depicts qualitative segmentation results, in accordance with example embodiments.

FIG. 7A depicts a graph of class-wise inconsistency changes, in accordance with example embodiments.

FIG. 7B depicts a graph of class-wise accuracy changes, in accordance with example embodiments.

FIG. 8 depicts a system, in accordance with example embodiments.

FIG. 9 depicts qualitative segmentation and depth results, in accordance with example embodiments.

FIG. 10 depicts a comparison table, in accordance with example embodiments.

FIG. 11 depicts a comparison table, in accordance with example embodiments.

FIG. 12 depicts a comparison table, in accordance with example embodiments.

FIG. 13 depicts a comparison table, in accordance with example embodiments.

FIG. 14 depicts qualitative segmentation and depth results, in accordance with example embodiments.

FIG. 15 depicts a comparison table, in accordance with example embodiments.

FIG. 16 depicts a comparison table, in accordance with example embodiments.

FIG. 17 depicts a comparison table, in accordance with example embodiments.

FIG. 18 depicts a block diagram of training and inference phases for an example machine learning model, in accordance with example embodiments.

FIG. 19 depicts a flowchart diagram illustrating a method, in accordance with example embodiments.

FIG. 20 depicts a flowchart diagram illustrating a method, in accordance with example embodiments.

### DETAILED DESCRIPTION

### Overview

An approach to developing UDA models may involve applying methods to small (i.e., lightweight) models/networks. However, this may result in reduced accuracy, which may result from having a small teacher model. For example, in synthetic-to-real adaptation experiments, performance degradation in lightweight models (e.g., MiT-B0) compared to heavyweight models (e.g., MiT-B5) may be observed. UDA methods may be combined with network compression techniques, such as pruning and neural architecture search, in image classification tasks. However, these methods may alter the architecture of the student model, which may reduce the applicability of exponential moving average (EMA)-based self-training and thereby may cause decreased performance. Thus, potentially limited flexibility in EMA-based self-training may pose challenges in directly employing lightweight models and/or applying network compression techniques. There may be interest in alleviating these constraints and balancing accuracy and efficiency in UDA semantic segmentation.

Semantic segmentation methods may fall into three categories: input, feature, and output-based. In the input space, image-to-image translation, generative adversarial networks and/or diffusion models may be used. Feature space methods may align distributions between domains and may employ statistical and/or heuristic methods, such as maximum classification discrepancy and/or adversarial learning. Output space strategies may involve self-training with pseudo-labels from a teacher model's output to train a student model. EMA-based self-training may be used for UDA semantic segmentation and may demonstrate high accuracy across benchmark segmentation tasks. Moreover, techniques, such as masking for context learning and foundation models (e.g., vision-language, segment anything) for pseudo-label refinement, may further enhance self-training approaches.

However, imbalanced distribution in source and target classes may degrade pseudo-label quality in self-training UDA methods. Accordingly, techniques like re-sampling (e.g., re-sampling rare classes), uncertainty estimation, re-weighting, and clustering may be used to mitigate this. An inconsistency-based loss may address the issue by facilitating the use of predictions from pre-adapted teacher and student models, which may fine-tune the student model.

The efficiency of models may be enhanced by applying one or more compression techniques, such as quantization, pruning, and knowledge distillation (KD), after domain adaptation (e.g., post-training). However, it may be beneficial to use techniques that concurrently address accuracy and efficiency during the domain adaptation process.

Network compression and UDA may be combined in different ways. For example, a structured pruning framework for convolutional neural networks (CNNs), using Taylor-based importance estimation and maximum mean discrepancy-based feature alignment, may be used. As another example, a structured pruning method, coupled with KD-based self-training, may be used. As a further example, neural architecture search (NAS)-based approaches may also be used and may show higher compression rates compared to the pruning methods. However, such approaches may be tailored for image classification tasks and may alter network architectures, which may pose a challenge in potential incompatibility (e.g., misalignment between teacher and student models) with EMA-based self-training. KD for UDA may be performed utilizing an adversarial loss, which may reduce cross-domain discrepancy. KD and UDA may also be performed by applying contrastive learning between a large (e.g., heavyweight) teacher model and a small (e.g., lightweight) student model, while still generating pseudo-labels from a small teacher model. Yet another approach to combining KD and UDA may be through the fusion of a teacher model's predictions at inference, which may improve performance. However, such a post-hoc design may require an additional network, which may increase inference costs.

One approach to advance the goals described above may be distilled unsupervised domain adaptation (DUDA), a self-training method coupled with KD. DUDA may improve the accuracy of lightweight models trained by the EMA-based self-training for UDA. To do so, DUDA may leverage a large (e.g., heavyweight) auxiliary student model between a large teacher model and a small student model, which may help to address potential architectural mismatch. The three models may be jointly trained in a single framework by KD between the large and small models and the EMA update between the large models. Doing so may facilitate the training of the lightweight student model with reliable and consistent pseudo-labels, which may reap the advantages of EMA-based self-training of larger models. Additionally, the inconsistency between the large teacher model and small student model may be used to identify under-performing classes in an unsupervised manner. Further, performance enhancement may be achieved by applying non-uniform weighting to the loss functions associated with these identified classes.

Such a training approach may differ from KD applied independently post-UDA, which may assign uniform importance to every class and may be prone to information losses in sequential distillation steps, which may thereby lead to suboptimal performance. DUDA may employ a combination of UDA and KD, which may incorporate pre-adaptation (gradual distillation from large to small models), inconsistency-based loss (prioritizing poorly adapted classes), and multiple teacher models (for enhanced learning).

DUDA may be used for efficient and domain-adaptive semantic segmentation models. DUDA using lightweight models may achieve comparable accuracy with heavyweight models in four UDA benchmarks. The use of DUDA may facilitate lightweight semantic segmentation models, which may have significant practical implications, such as for robotics. DUDA may be combined with other self-training UDA methods and may demonstrate accuracy improvements of around 10%, such as in lightweight transformer-based models. DUDA may show improved performance in heterogeneous self-training between transformer-based models and CNN-based models and may show improved accuracy, such as in DeepLab-V2, which may even surpass supervised learning baselines.

In the multi-task domain, UDA for multi-task dense prediction tasks may use adversarial learning. For example, a discriminator network may be employed at the model output to classify whether predictions originate from the source domain or the target domain. Domain adaptation may proceed as the model learns to fool the discriminator. This strategy may integrate easily into existing frameworks.

UDA for multi-task dense prediction tasks may use architectures that balance task-specific feature extraction with shared representations. For example, encoder methods may disentangle task-specific representations within the encoder through multi-stream architectures, such as activation mixing across tasks, attention modules to separate shared and task-specific features, and/or branching pathways. In some embodiments, low-rank adapters may improve efficiency. In some embodiments, decoder-focused methods may be used. Such methods may use a shared backbone with specialized decoders that may improve interactions. These methods may include cross-task knowledge transfer, attention mechanisms, and consistency regularization. Beyond architectural innovations, optimization strategies, such as gradient alignment, uncertainty-based task weighting, and/or dynamic gradient tuning, may also facilitate balancing learning across tasks to improve multi-task learning.

In some embodiments, decoder designs may be used may be combined with cross-task distillation, cross-task attention, and/or task-adapted attention. As a yet further example, depth estimation may be leveraged to support UDA in semantic segmentation, such as where depth is an auxiliary signal to estimate adaptation difficulties and/or to spatially align depth maps with segmentation representations. A still further example may use self-training, in which a teacher model may generate pseudo-labels on target-domain data, a student model may be trained under the teacher's supervision, and model parameters corresponding to the teacher model may be updated based on the model parameters corresponding to the student model (e.g., via an exponential moving average (EMA) of the model parameters corresponding to the student model). Such self-training methods may include the use of a foundation model to refine pseudo-labels (e.g., semantic segmentation), a segment anything model (SAM)-based pseudo-label refinement in a weakly supervised setting for illumination adaptation, and/or the integration of a SAM into UDA frameworks for three dimensional (3D) semantic segmentation.

In some embodiments, self-training may be useful for semantic segmentation, however this approach may have difficulty with multi-task setups because augmentation techniques that mix source images and target images may not be applicable to depth estimation due to inconsistent depth scales. Further, large discrepancies in viewpoint and scale across domains may limit the transferability of source-domain knowledge, which may make it difficult for the teacher model to produce reliable pseudo-labels. As a result, self-training approaches for single-task UDA may not directly extend to multi-task learning, which may pose a technical gap between adversarial-learning-based multi-task UDA and self-training-based single-task UDA.

Another method for multi-task UDA may include use of foundation model assisted multi-task unsupervised domain adaptation (FAMDA), which may enable efficient and domain-adaptive dense prediction by harnessing vision foundation models (VFMs). VFMs may have zero-shot generalization, which may make them applicable across diverse environments without additional fine-tuning. VFMs may be powerful teachers in UDA setups. Self-training-based UDA may incorporate one or more VFMs (e.g., a SAM, a depth anything model (DAM)) to provide high-quality pseudo-labels for other models. In some embodiments, a SAM may not directly generate semantic predictions. In some embodiments, the teacher model's pseudo-labels may be refined. In some embodiments, a DAM may directly produce reliable pseudo-depth maps that may be used to supervise the student model. By combining self-training-based UDA with VFMs, FAMDA may be an effective method for constructing domain-adaptive and efficient multitask prediction models. Such a framework may introduce knowledge distillation from VFMs into a single model, indirectly (e.g., through a SAM) and/or directly (e.g., through a DAM). The benefits of this distillation may be further realized in effective training of lightweight models. Thus, FAMDA may be useful for resource-constrained applications where multi-task learning may be beneficial, such as robotics.

In some embodiments, FAMDA may achieve strong performance across multiple synthetic-to-real UDA multi-task learning benchmarks and real-to-real adaptation tasks (e.g., day-to-night, low-light data). FAMDA may have strong robustness and efficiency across a family of model variants (e.g., MiT-B0, MiT-B2, MiT-B3, MiT-B5, ResNet-101). For example, a lightweight model (e.g., MiT-B2) may have high accuracy while being 10 times smaller than a DAM, 27 times smaller than SAM, and processing images with 53% less latency than a DAM. Such efficiency may enable near real-time performance (e.g., 7 hertz (Hz)), which may facilitate deployment on robotics platforms, for augmented reality (AR), or virtual reality (VR), where low latency and efficiency may be useful.

In some embodiments, FAMDA may integrate vision foundation models into self-training-based UDA for multi-task learning, which may enable effective knowledge distillation from large-scale pre-trained models. FAMDA may achieve strong performance while remaining lightweight and practical for resource-constrained robotics applications. FAMDA may be validated synthetic-to-real benchmarks and day-to-night adaptation scenarios (e.g., a low-light dataset). FAMDA may be deployed in diverse environments, which may necessitate domain adaptation to bridge the gap between labeled source data and unlabeled target domains.

### DUDA

### Method Description

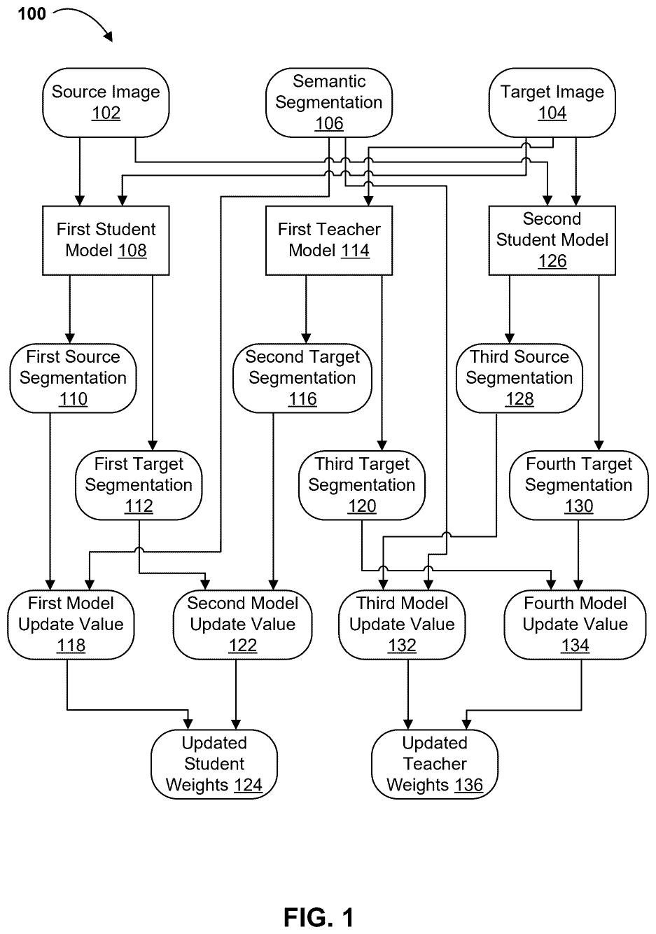

FIG. 1 depicts system 100, in accordance with example embodiments. In some embodiments, system 100 may include first student model 108, first teacher model 114, and second student model 126.

In some embodiments, first student model 108, first teacher model 114, and/or second student model 126 may receive source image 102, target image 104, and/or semantic segmentation 106. In some embodiments, source image 102 may be one of a plurality of source image 102. Similarly, in some embodiments, target image 104 may be one of a plurality of target image 104. In some embodiments, source image 102 may be one of the plurality of target image 104. Similarly, in some embodiments, target image 104 may be one of the plurality of source image 102.

In some embodiments, system 100 may be used to improve the performance of one or more models (e.g., neural networks) without the use of labels for target image 104.

Semantic segmentation 106 may include pixel-wise annotations of source image 102. For example, for all or a subset of pixels within source image 102, semantic segmentation 106 may include a value corresponding to a class associated with the pixel (e.g., if a pixel in source image 102 depicts a car, the value of semantic segmentation 106 associated with that pixel in source image 102 may have a value corresponding to “car”). In some embodiments, one or more pixels in source image 102 may be associated with one or more classes (e.g., a pixel in source image 102 may depict both a person and a car). In such embodiments, one or more pixels in source image 102 may correspond to more than one value in semantic segmentation 106 (e.g., a pixel in source image 102 may correspond to values of both “car” and “person” in semantic segmentation 106).

In some embodiments, source image 102, target image 104, and semantic segmentation 106 may have the same dimensions (e.g., a height of H pixels and a width of W pixels). In other embodiments, source image 102, target image 104, and semantic segmentation 106 may not have the same dimensions.

As used herein, source image 102 may be represented mathematically as x_{src}, target image 104 may be represented mathematically as x_{tgt}, semantic segmentation 106 may be represented mathematically as y_{src}, first student model 108 may be represented mathematically as f_{θ;stu}, first teacher model 114 may be represented mathematically as g_{φ;tea}, and second student model 126 may be represented mathematically as g_{φ;stu}.

In some embodiments, first student model 108, first teacher model 114, and second student model 126 may all be the same model (e.g., first student model 108, first teacher model 114, and second student model 126 may all be CNNs, all be transformers, or all be recurrent neural networks (RNNs)). In other embodiments, first student model 108, first teacher model 114, and second student model 126 may not all be the same model (e.g., first student model 108 may be a CNN, while first teacher model 114 and second student model 126 are transformer-based models). In some embodiments, first student model 108 may be smaller (e.g., have fewer parameters) than either first teacher model 114 or second student model 126, which may facilitate the use of first student model 108 in applications that may benefit from lower latency, such as robotics.

In some embodiments, based on the interaction between first student model 108 and source image 102, first student model 108 may generate first source segmentation 110. In some embodiments, first source segmentation 110 may include pixel-wise annotations of source image 102. In some embodiments, the generation of first source segmentation 110 may be based on the interaction between source image 102 and one or more weights corresponding to first student model 108 (e.g., weights corresponding to each pixel of source image 102).

In some embodiments, based on the interaction between first student model 108 and target image 104, first student model 108 may generate first target segmentation 112. In some embodiments, first target segmentation 112 may include pixel-wise annotations of target image 104. In some embodiments, the generation of first target segmentation 112 may be based on the interaction between target image 104 and one or more weights corresponding to first student model 108 (e.g., weights corresponding to each pixel of target image 104).

In some embodiments, based on the interaction between first teacher model 114 and target image 104, first teacher model 114 may generate second target segmentation 116. In some embodiments, second target segmentation 116 may include pixel-wise annotations of target image 104. In some embodiments, the generation of second target segmentation 116 may be based on the interaction between target image 104 and one or more weights corresponding to first teacher model 114 (e.g., weights corresponding to each pixel of target image 104).

Similarly, in some embodiments, based on the interaction between first teacher model 114 and target image 104, first teacher model 114 may generate third target segmentation 120. In some embodiments, third target segmentation 120 may include pixel-wise annotations of target image 104. In some embodiments, the generation of third target segmentation 120 may be based on the interaction between target image 104 and one or more weights corresponding to first teacher model 114 (e.g., weights corresponding to each pixel of target image 104).

In some embodiments, based on the interaction between second student model 126 and source image 102, second student model 126 may generate third source segmentation 128. In some embodiments, third source segmentation 128 may include pixel-wise annotations of source image 102. In some embodiments, the generation of third source segmentation 128 may be based on the interaction between source image 102 and one or more weights corresponding to second student model 126 (e.g., weights corresponding to each pixel of source image 102).

Similarly, in some embodiments, based on the interaction between second student model 126 and target image 104, second student model 126 may generate fourth target segmentation 130. In some embodiments, fourth target segmentation 130 may include pixel-wise annotations of target image 104. In some embodiments, the generation of fourth target segmentation 130 may be based on the interaction between target image 104 and one or more weights corresponding to second student model 126 (e.g., weights corresponding to each pixel of target image 104).

In some embodiments, second target segmentation 116 and/or third target segmentation 120 may be referred to as “pseudo-labels” of target image 104.

In some embodiments, model parameters (e.g., weights) corresponding to first student model 108, first teacher model 114, and/or second student model 126 may change/update (e.g., across iterations, across images, across values of hyperparameters). For example, first student model 108 may have a first set of model parameters at one iteration and a second set of model parameters at a second iteration. In some embodiments, updated student weights 124 may correspond to this second set of model parameters. In some embodiments, model parameters corresponding to first student model 108, first teacher model 114, and/or second student model 126 may change based on first source segmentation 110, semantic segmentation 106, first target segmentation 112, second target segmentation 116, third target segmentation 120, third source segmentation 128, and/or fourth target segmentation 130.

In some embodiments, the changes to model parameters (e.g., weights) corresponding to first student model 108, first teacher model 114, and/or second student model 126 may occur in one or more phases. For example, model parameters corresponding to first student model 108, first teacher model 114, and/or second student model 126 may change in a first phase and, in a second, subsequent phase, model parameters corresponding to first student model 108 may change while model parameters corresponding to first teacher model 114 and/or second student model 126 may not change. Updating the model parameters corresponding to first student model 108 in this manner may facilitate improving the performance of first student model 108 for certain classes.

In some embodiments, updated student weights 124 may be determined based on first model update value 118 and/or second model update value 122. In some embodiments, first model update value 118 may be based on first source segmentation 110 and/or semantic segmentation 106. In some embodiments, first model update value 118 may be based on the cross-entropy between first source segmentation 110 and semantic segmentation 106. The use of cross-entropy in this manner may improve the pixel-wise classification rate of first student model 108. In other embodiments, first model update value 118 may be based on the other relationships between first source segmentation 110 and semantic segmentation 106, such as those that that compare pixel wise class labels for segmentation (e.g., SoftIOU loss, focal loss, recall loss, class-balanced loss).

In some embodiments, the cross-entropy between first source segmentation 110 and semantic segmentation 106 may represented mathematically as [symbol] and may be expressed using the following mathematical expression

$${ℒ}_{CE ; src} = - {\sum }_{i = 1}^{H * W} {\sum }_{c = 1}^{C} {y}_{src}^{i , c} * log ( {{f}_{θ ; stu} ( {x}_{src} )}^{i , c} ) , \qquad ( Eqn . 1 )$$

where

$${y}_{src}^{i , c}$$

is the cth class of the ith pixel in semantic segmentation 106, f_{θ;stu} (x_{src})^{i,c} is the cth class of the ith pixel in first source segmentation 110, and C is the number of classes corresponding to source image 102 (e.g., 10 classes, 20 classes, 100 classes, 150 classes, 1,000 classes).

In some embodiments, second model update value 122 may be based on first target segmentation 112 and/or second target segmentation 116. In some embodiments, second model update value 122 may be based on the cross-entropy between first target segmentation 112 and second target segmentation 116. The use of cross-entropy in this manner may improve the pixel-wise classification rate of first teacher model 114 and/or first student model 108. In other embodiments, second model update value 122 may be based on the other relationships between first target segmentation 112 and second target segmentation 116 (e.g., SoftIOU loss, focal loss, recall loss, class-balanced loss).

In some embodiments, first model update value 118 may be based on a first relationship between first source segmentation 110 and semantic segmentation 106 and second model update value 122 may also be based on the first relationship between first target segmentation 112 and second target segmentation 116 (e.g., both may be based on cross-entropy). In other embodiments, first model update value 118 may be based on a first relationship between first source segmentation 110 and semantic segmentation 106 and second model update value 122 may also be based on a second relationship between first target segmentation 112 and second target segmentation 116 (e.g., the first relationship may be cross entropy and the second relationship may be SoftIOU).

In some embodiments, the cross-entropy between first target segmentation 112 and second target segmentation 116 may represented mathematically as [symbol] and may be expressed using the following mathematical expression

$${ℒ}_{CE ; tgt} = - {\sum }_{i = 1}^{H * W} {\sum }_{c = 1}^{C} {\hat{y}}_{tgt}^{i , c} * log ( {{f}_{θ ; stu} ( {x}_{tgt} )}^{i , c} ) , \qquad ( Eqn . 2 )$$

where f_{θ;stu} (x_{tgt})^{i,c} is the cth class of the ith pixel in first target segmentation 112 and C is the number of classes corresponding to target image 104 (e.g., 10 classes, 20 classes, 100 classes, 150 classes, 1,000 classes). In some embodiments, ŷ_{tgt}^{i,c} may be the cth class of the ith pixel in second target segmentation 116 (e.g., ŷ_{tgt}^{i,c} may be g_{θ;tea} (x_{tgt})^{i,c}). In other embodiments, ŷ_{tgt}^{i,c} may be based on g_{φ;tea}(x_{tgt})^{i,c}. For example, ŷ_{tgt}^{i,c} may be based on the following mathematical expression

$${\hat{y}}_{tgt}^{i , c} = h ( {g}_{φ ; tea} ( {x}_{tgt} ) ) , \qquad ( Eqn . 3 )$$

where h(·) is an encoding function (e.g., a one hot encoding function).

In some embodiments, second model update value 122 may be based on the Kullback-Leibler Divergence between first target segmentation 112 and second target segmentation 116. The use of the Kullback-Leibler Divergence in this manner may distill representation information from first teacher model 114 to first student model 108. In some embodiments, the Kullback-Leibler Divergence between first target segmentation 112 and second target segmentation 116 may be represented mathematically as [symbol] and may be expressed using the following mathematical expression

$${ℒ}_{KL ; tgt} = {g}_{φ ; tea} ( {x}_{tgt} ) log ( \frac{{g}_{φ ; tea} ( {x}_{tgt} )}{{f}_{θ ; stu} ( {x}_{tgt} )} ) . \qquad ( Eqn . 4 )$$

In other embodiments, the Kullback-Leibler Divergence may be determined between second target segmentation 116 and third source segmentation 128 and may be expressed using the following mathematical expression

$${ℒ}_{KL ; tgt} = {g}_{φ ; stu} ( {x}_{tgt} ) log ( \frac{{g}_{φ ; stu} ( {x}_{tgt} )}{{f}_{θ ; stu} ( {x}_{tgt} )} ) . \qquad ( Eqn . 5 )$$

In some embodiments, second model update value 122 may be based on the cross-entropy between first target segmentation 112 and second target segmentation 116 (e.g., a cross-entropy loss) and the Kullback-Leibler Divergence between first target segmentation 112 and second target segmentation 116 (e.g., a Kullback-Leibler Divergence loss). In some embodiments, use of the Kullback-Leibler Divergence loss may provide rich representation information when combined with the cross-entropy loss. In some embodiments, this combination of the Kullback-Leibler Divergence loss and the cross-entropy loss may facilitate the learning of first student model 108 of both hard labels (e.g., those represented in one-hot vectors) but also the continuous output distribution, which may indicate correlations between classes.

In some embodiments, model parameters (e.g., weights) corresponding to second student model 126 may be used to update model parameters corresponding to first teacher model 114. The process by which the model parameters corresponding to second student model 126 are used to update the model parameters corresponding to first teacher model 114 may be referred to as “self-training.”

As stated above, model parameters corresponding to first teacher model 114 may be updated based on model parameters corresponding to second student model 126. For example, at the nth iteration, model parameters corresponding to first teacher model 114 may be updated based on a moving average (e.g., an exponential moving average) of model parameters corresponding to second student model 126 and model parameters corresponding to first teacher model 114 at previous iterations. For example, second student model 126 may be used to update model parameters corresponding to first teacher model 114 based on the following expression.

$${φ}_{tea} ( n ) = {αφ}_{tea} ( n - 1 ) + ( 1 - α ) {φ}_{stu} ( n - 1 ) , \qquad ( Eqn . 6 )$$

where φₜₑₐ (n) represents model parameters corresponding to first teacher model 114 at iteration n, φₜₑₐ(n−1) represents model parameters corresponding to first teacher model 114 at iteration n−1, φₛₜᵤ(n−1) represents model parameters corresponding to second student model 126 at the iteration n−1, and a is a constant (e.g., a real number between 0 and 1).

In some embodiments, the model parameters corresponding to first teacher model 114 may be updated based on each update to the model parameters corresponding to second student model 126. Updating the model parameters corresponding to first teacher model 114 in this manner may facilitate the creation of a smoother teacher, which may lead to more stable training of second student model 126. In other embodiments, the model parameters corresponding to first teacher model 114 may be updated based on a subset of updates to the model parameters corresponding to second student model 126 (e.g., the model parameters corresponding to first teacher model 114 may be updated based on the updates to the model parameters corresponding to second student model 126 corresponding to the first hundred iterations, even iterations, every hundred iterations, or after ten thousand iterations).

In some embodiments, the value of a in Eqn. 6 may change across iterations. For example, the value of a may decrease as the number of iterations increase. As another example, the value of a may increase as the number of iterations increase (e.g., the value of a may increase as the predictions become more confident).

In some embodiments, the model parameters corresponding to first teacher model 114 may change in other ways. For example, the model parameters corresponding to first teacher model 114 may be updated to updated teacher weights 136. In some embodiments, updated teacher weights 136 may be determined based on third model update value 132 and/or fourth model update value 134. In some embodiments, third model update value 132 may be based on third source segmentation 128 and/or semantic segmentation 106. In some embodiments, third model update value 132 may be based on the cross-entropy between third source segmentation 128 and semantic segmentation 106. The use of cross-entropy in this manner may improve the pixel-wise classification rate of second student model 126. In other embodiments, third model update value 132 may be based on other relationships between third source segmentation 128 and semantic segmentation 106 (e.g., SoftIOU loss, focal loss, recall loss, class-balanced loss).

In some embodiments, the cross-entropy between third source segmentation 128 and semantic segmentation 106 may represented mathematically as [symbol] and may be expressed using the following mathematical expression

$${ℒ}_{CE ; src} = - {\sum }_{i = 1}^{H * W} {\sum }_{c = 1}^{C} {y}_{src}^{i , c} * log ( {{g}_{φ ; stu} ( {x}_{src} )}^{i , c} ) , \qquad ( Eqn . 7 )$$

where

$${y}_{src}^{i , c}$$

is the cth class of the ith pixel in semantic segmentation 106, g_{φ;stu}(x_{src})^{i,c} is the cth class of the ith pixel in third source segmentation 128, and C is the number of classes corresponding to source image 102 (e.g., 10 classes, 20 classes, 100 classes, 150 classes, 1,000 classes).

In some embodiments, fourth model update value 134 may be based on third target segmentation 120 and/or fourth target segmentation 130. In some embodiments, fourth model update value 134 may be based on the cross-entropy between third target segmentation 120 and fourth target segmentation 130. The use of cross-entropy in this manner may improve the pixel-wise classification rate of second student model 126. In some embodiments, the cross-entropy between third target segmentation 120 and fourth target segmentation 130 may represented mathematically as [symbol] and may be expressed using the following mathematical expression

$${ℒ}_{CE ; tgt} = - {\sum }_{i = 1}^{H * W} {\sum }_{c = 1}^{C} {\hat{y}}_{tgt}^{i , c} * log ( {{g}_{φ ; stu} ( {x}_{tgt} )}^{i , c} ) , \qquad ( Eqn . 8 )$$

where g_{φ;stu}(x_{tgt})^{i,c} is the cth class of the ith pixel in fourth target segmentation 130 and C is the number of classes corresponding to target image 104 (e.g., 10 classes, 20 classes, 100 classes, 150 classes, 1,000 classes). In some embodiments, ŷ_{tgt}^{i,c} may be the cth class of the ith pixel in third target segmentation 120 (e.g., ŷ_{tgt}^{i,c} may be g_{φ;tea} (x_{tgt})^{i,c}). In other embodiments, ŷ_{tgt}^{i,c} may be based on g_{φ;tea}(x_{tgt})^{i,c}. For example, ŷ_{tgt}^{i,c} may be based on the following mathematical expression

$${\hat{y}}_{tgt}^{i , c} = h ( {g}_{φ ; tea} ( {x}_{tgt} ) ) , \qquad ( Eqn . 9 )$$

where h(·) is an encoding function (e.g., a one hot encoding function).

In some embodiments, model parameters (e.g., weights) corresponding to second student model 126 may be updated. For example, model parameters (e.g., weights) corresponding to second student model 126 may be updated based on third target segmentation 120, third source segmentation 128, and/or fourth target segmentation 130.

In some embodiments, updating first student model 108, first teacher model 114, and/or second student model 126 in the manner described above may enhance the efficiency of first student model 108 and may enable first teacher model 114 to produce high-quality pseudo-labels. In some embodiments, use of such pseudo-labels may improve the performance of first student model 108 because small models may achieve strong performance with supervision (e.g., the use of high-quality pseudo-labels) even in cases where first student model 108 is a smaller model than either first teacher model 114 or second student model 126.

In some embodiments, first teacher model 114 may generate pseudo-labels for both first student model 108 and second student model 126. In some embodiments, the use of second student model 126 may facilitate the EMA update of first teacher model 114. In some embodiments, such a design may facilitate the application of EMA-based self-training methods to first teacher model 114 and second student model 126, which may facilitate the generation of robust training signals for first student model 108.

In some embodiments, there may be a difference in performance between first student model 108, first teacher model 114, and/or second student model 126. In some embodiments, this difference in performance may be larger for classes that are less represented in the plurality of source image 102 and/or the plurality of target image 104. For example, first student model 108, first teacher model 114, and second student model 126 may have high performance for classes that are common among the plurality of source image 102 and/or the plurality of target image 104 (e.g., “sky,” “road”) but may have lower performance for less commonly occurring classes (e.g., “train,” “motorbike”). Though KD may help reduce such a performance gap, the pre-adaptation procedure may not address this imbalanced performance issue. In some embodiments, the presence of less commonly occurring classes (e.g., less represented classes) in the plurality of target image 104 may hinder the accurate classification of less commonly occurring classes because the identification of such classes may not be directly possible due to the absence of target labels corresponding to such classes.

To help reduce issues related to less represented classes, a class-wise inconsistency measure, represented mathematically as I_{c}, may be used to quantify the inconsistency in the prediction results between pair-wise combinations of first student model 108, first teacher model 114, and second student model 126. Doing so may approximately estimate the class-wise performance of first student model 108, first teacher model 114, and/or second student model 126 with respect to the plurality of target image 104. In some embodiments, I_{c} may be based on the intersection and union of results from first student model 108, first teacher model 114, and/or second student model 126. In some embodiments, the ratio of g_{φ;tea}(x_{tgt}) and f_{θ;stu}(x_{src}) may be used as an indicator of classes for which one or more of first student model 108, first teacher model 114, and second student model 126 have lower performance. For example, a high ratio may indicate the prediction of first student model 108 may be different from that of first teacher model 114. In some embodiments, the inconsistency for the object class c, I_{c}, may be expressed mathematically as

$${I}_{c} = \frac{{\sum }_{t} {i}_{c} ( t )}{{\sum }_{t} {n}_{c} ( t )} , \qquad ( Eqn . 10 )$$

where i_{c}(t) represents the inconsistency for the object class c at iteration t and n_{c}(t) is binary variable indicating the presence of class c in the image corresponding to iteration t. In some embodiments, i_{c}(t) may be expressed mathematically as

$${i}_{c} ( t ) = 1 - \frac{{s}_{c} ( t )}{{u}_{c} ( t )} \qquad ( Eqn . 11 )$$

where s_{c}(t) represents the intersection between the predicted classes between first student model 108 and first teacher model 114 and may be expressed mathematically as

$${s}_{c} ( t ) = {\sum }_{i} 1 {( {g}_{φ ; tea} ( {x}_{tgt} ) )}^{i , c} \cdot 1 {( {f}_{θ ; stu} ( {x}_{tgt} ) )}^{i , c} , \qquad ( Eqn . 12 )$$

and u_{c}(t) represents the union between the predicted classes between first student model 108 and first teacher model 114 and be expressed mathematically as

$${u}_{c} ( t ) = {\sum }_{i} 1 {( {g}_{φ ; tea} ( {x}_{tgt} ) )}^{i , c} + {\sum }_{i} 1 {( {f}_{θ ; stu} ( {x}_{tgt} ) )}^{i , c} - {\sum }_{i} 1 {( {g}_{φ ; tea} ( {x}_{tgt} ) )}^{i , c} \cdot 1 {( {f}_{θ ; stu} ( {x}_{tgt} ) )}^{i , c} , \qquad ( Eqn . 13 )$$

where i is a pixel in target image 104.

In some embodiments, n_{c}(t) may have a value of 0 when u_{c}(t) is less than a threshold (e.g., 0.1%) across all pixels in target image 104 and a value of 1 when u_{c}(t) is greater than the threshold (e.g., 0.1%) across all pixels in target image 104. The value of the threshold may take on values between 0.001% and 1%. In some embodiments, the value of the threshold may change across iterations (e.g., the threshold may have a value of 0.01% for 1,000 iterations and then may have a value of 0.05% after 1,000 iterations). In some embodiments, when the value of the threshold is low, it may indicate that there is a low prediction rate for class c.

As described above, in some embodiments, model parameters (e.g., weights) corresponding to first student model 108, first teacher model 114, and/or second student model 126 may change in a first phase and, in a second, subsequent phase, model parameters corresponding to first student model 108 may change while model parameters corresponding to first teacher model 114 and/or second student model 126 may not change. In some embodiments, high-quality pseudo-labels, which may be generated using first teacher model 114, may be generated towards the conclusion of the first phase (e.g., as the number of iterations increases). In some embodiments, in the second phase, first student model 108 may be refined using these high-quality pseudo-labels. In some embodiments, first teacher model 114 and/or second student model 126 may not change during the second phase.

In some embodiments, the number of iterations in the first phase may be the same as the number of iterations in the second phase. In other embodiments, the number of iterations in the first phase may be different from the number of iterations in the second phase. For example, there may be 40,000 iterations in the first phase and 80,000 iterations in the second phase.

In some embodiments, different seeds may be used to initialize one or more of first student model 108, first teacher model 114, and/or second student model 126. For example, three seeds may be used to initialize one or more of first student model 108, first teacher model 114, and/or second student model 126.

In some embodiments, the performance of first teacher model 114 and second student model 126 may saturate at a similar level, which may indicate that either first teacher model 114 or second student model 126 may produce high-quality pseudo-labels. In some embodiments, first student model 108 may acquire knowledge directly from first teacher model 114 during the first stage and first student model 108 may be refined using pseudo-labels from second student model 126 during the second phase. In some embodiments, KD may be applied during the second stage (e.g., the loss function for first student model 108 may include both a cross-entropy loss and a Kullback-Leibler Divergence loss). In other embodiments, KD may not be applied during the second stage. In some embodiments, the inconsistency, I_{c}, described above may be used to balance the relative importance of cross-entropy and Kullback-Leibler Divergence. Doing so may emphasize soft labels and de-emphasizing hard labels, which may may improve performance for poor-performing (e.g., less represented) classes. For instance, the Kullback-Leibler Divergence may be given more weight when I_{c} is relatively high. In this way, during the second phase, the model parameters corresponding to first student model 108 may be updated (e.g., to produce updated student weights 124) based on the following loss function

$$ℒ = {ℒ}_{CE ; src} + {\sum }_{c} ( 2 - {I}_{c}^{′} ) \cdot {ℒ}_{CE ; tgt}^{( c )} + {{\sum }_{c} {I}_{c}^{′}}_{} \cdot {{ℒ}_{KL ; {tgt}^{′}}^{( c )}}_{} \qquad ( Eqn . 14 )$$

where

$${I}_{c}^{′}$$

is the normalized inconsistency and may be expressed mathematically as

$${I}_{c}^{′} = C \cdot \frac{{I}_{c}}{{\sum }_{c} {I}_{c}} , \qquad ( Eqn . 15 )$$

where C is the number of classes. For example, the number of classes may be 19 for the Cityscapes (CS) dataset. In some embodiments, the coefficients

$$( 2 - {I}_{c}^{′} ) and {I}_{c}^{′}$$

in Eqn. 14 may facilitate making the sum of the terms be the same as where inconsistency is not used to balance the relative importance of cross-entropy and Kullback-Leibler Divergence. In other embodiments, these coefficients may be different.

In some embodiments, system 100 may be a model-agnostic framework and may be applicable to different architectures (e.g., DeepLab, ResNet-based models, SegFormer MiT transformer-based models). In some embodiments, MiT-B5 may be used as a backbone in first teacher model 114 and/or second student model 126. In some embodiments, lighter weight backbones (e.g., MiT-B0, MiT-B1, MiT-B2, MiT-B4) may be used in first student model 108. In some embodiments, first student model 108 may not be a transformer-based model. For example, there may be heterogeneous self-training, in which first teacher model 114 and second student model 126 may be transformer-based model, while first student model 108 may be CNN-based model (e.g., based on DeepLab-V2). In some embodiments, a ResNet-based model (e.g., based on DeepLab-V2, based on ResNet-50, based on ResNet-18) may be used as a backbone in first student model 108. In some embodiments, the DAFormer model and/or the HRDA model may be used for the decoder heads of first student model 108, first teacher model 114, and/or second student model 126.

In some embodiments, model parameters corresponding to teacher segmentation decoder 828 may be updated based on model parameters corresponding to student segmentation decoder 814 (e.g., via EMA updates such as those depicted in Eqn. 16). In other embodiments, model parameters corresponding to teacher segmentation decoder 828 may be updated based on model parameters corresponding to student depth decoder 816 (e.g., via EMA updates such as those depicted in Eqn. 16). This may be referred to as “depth→seg distillation.” Such distillation may occur for all iterations corresponding to updates to teacher segmentation decoder 828 or for a subset of iterations corresponding to updates to teacher segmentation decoder 828 (e.g., the first hundred iterations, the first twenty thousand iterations, even iterations, every hundred iterations, or after twenty thousand iterations)

As described above, in some embodiments, teacher model 822 may also be configured to estimate depth information based on source image 802 and/or target image 804. For example, teacher model 822 may have a teacher depth decoder that determines teacher depth based on teacher intermediate output 826. In some embodiments, model parameters corresponding to the teacher depth decoder may be updated based on model parameters corresponding to student depth decoder 816 (e.g., via EMA updates such as those depicted in Eqn. 16). In other embodiments, model parameters corresponding to the teacher depth decoder may be updated based on model parameters corresponding to student segmentation decoder 814 (e.g., via EMA updates such as those depicted in Eqn. 16). This may be referred to as “seg→depth distillation.” Such distillation may occur for all iterations corresponding to updates to the teacher depth decoder or for a subset of iterations corresponding to updates to the teacher depth decoder (e.g., the first hundred iterations, the first twenty thousand iterations, even iterations, every hundred iterations, or after twenty thousand iterations)

### Experimental Results

In some embodiments, both source image 102 and target image 104 may be drawn from the same dataset. For example, source image 102 and target image 104 may be drawn from the GTA dataset, which may include approximately 24,000 images of size 1,914 pixels by 1,052 pixels, the Synthia (SYN) dataset, which may include approximately 9,400 images of size 1,280 pixels by 760 pixels, the CS dataset, which may include images taken during clear daytime conditions and may include approximately 3,000 images of size 2,048 pixels by 1,024 pixels, DarkZurich (DZur), which may include images taken at night, and/or ACDC, which may include images taken during in fog, rain, and/or snow. In other embodiments, source image 102 and target image 104 may be drawn from different datasets.

In other embodiments, source image 102 and target image 104 may be drawn from multiple datasets (e.g., source image 102 and target image 104 may be drawn from a first dataset at one iteration and drawn from a second dataset at a second, subsequent iteration). For example, source image 102 and target image 104 may be drawn from images in the GTA and/or Synthia datasets and then source image 102 and target image 104 may be drawn from the CS dataset. This may be expressed as “GTA→CS” or “SYN→CS,” respectively. As another example, source image 102 and target image 104 may be drawn from the CS dataset and then source image 102 and target image 104 may be drawn from the DZur dataset. This may be expressed as “CS→DZur.” As a further example, source image 102 and target image 104 may be drawn from the CS dataset and then source image 102 and target image 104 may be drawn from the ACDC dataset. This may be expressed as “CS→ACDC.”

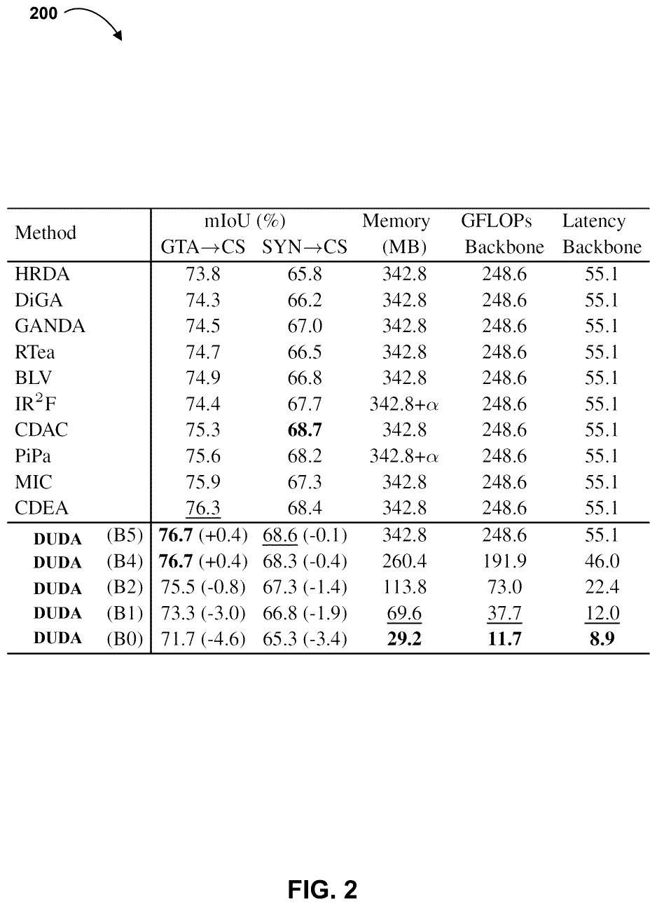

FIG. 2 depicts a table 200 of accuracy and inference costs, in accordance with example embodiments. In the columns from left to right, table 200 displays accuracy, memory, giga floating-point operations per second (GFLOPS), and latency in synthetic-to-real adaptation experiments. To determine the value in the column corresponding to GFLOPs and the column corresponding to latency, a single image of 512 pixels by 1,024 pixels may be considered with an overlapping sliding window process in a NVIDIA® RTX® A5000 graphics processing unit (GPU). The bottom five rows in table 200 depict the performance of first student model 108 across different model architectures. Table 200 may be generated based on system 100.

In table 200, accuracy is measured as mean intersection over the union (mIoU). In some embodiments, mIoU may be determined as the average, across classes, of the number of pixels classified as part of a class that are part of that class (true positives) divided by the sum of the number of pixels classified as part of a class that are part of that class (true positives), the number of pixels classified as part of a class that are not part of that class (false positives), and the number of pixels not classified as part of a class that are part of that class (false negatives).

As depicted in table 200, first student model 108 may have greater reductions in computational costs for smaller architectures, which may be implemented by smaller backbones. For example, using a MiT-B0 model for first student model 108 compared with using a MiT-B5 for first student model 108 may be approximately twelve times smaller, have approximately two times fewer FLOPs, and have an approximately 3-6% decrease in accuracy. As another example, using a MiT-B2 backbone may be one third the model size and use one third the model FLOPs compared with the use of a MiT-B5 backbone.

As seen in FIG. 2, existing methods (e.g., MIC) may show substantially more degradation in accuracy with small backbones. Further, using the MiT-B2 backbone (with about three times smaller model size and backbone FLOPs than MiT-B5), DUDA models (e.g., models based on system 100) may achieve comparable performance to other methods. Thus, system 100 may have strong inference results compared to other methods in inference, meaning that system 100 may deliver similar accuracy with lower memory usage compared to other models.

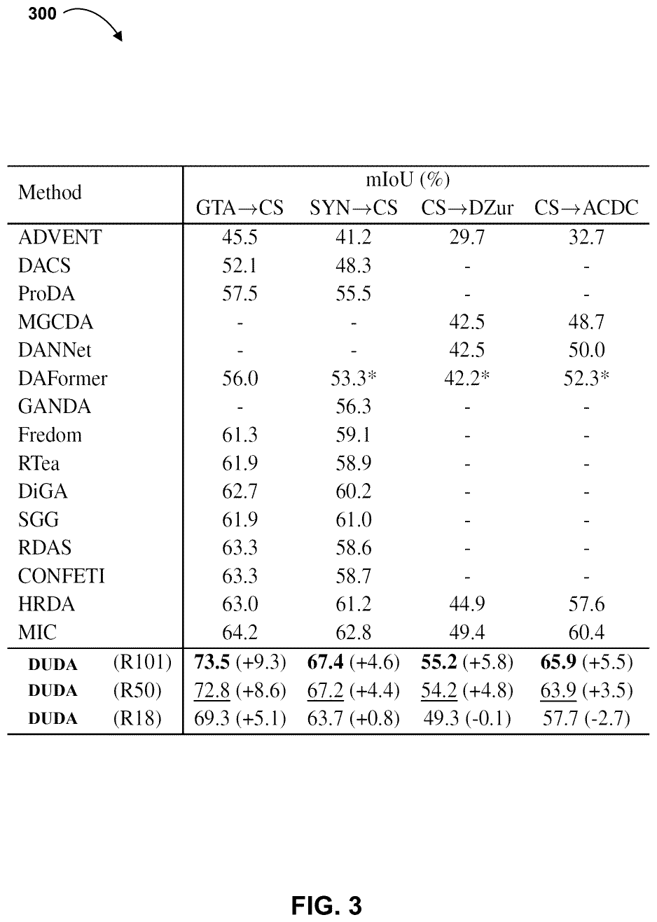

FIG. 3 depicts a comparison table 300, in accordance with example embodiments. As depicted in table 300, the performance of methods based on system 100 may be compared with that of ResNet-based networks. In table 300, the terms “R101,” “R50,” and “R18” stand for ResNet-101 backbone in DeepLab-V2 architecture, ResNet-50 backbone in DeepLab-V2 architecture, and ResNet-18 backbone in DeepLab-V2 architecture, respectively. Table 300 suggests that first student model 108 may be effective in both transformer-based and Res-Net-based models. Table 300 may be generated based on system 100.

As seen in FIG. 3, models that incorporate system 100 (e.g., DUDAMIC) can surpasses the accuracy of models that do not incorporate system 100 (e.g., baseline MIC with a DeepLab-V2 backbone). The improvements in accuracy may be by a noticeable margin (e.g., between 4.6% and 9.3% mIoU)

In some cases, the performance gap between Transformer-based and ResNet-based architectures may be large. For example, DeepLab-V2 trained with MIC may achieve mIoU scores of 64.2%, 62.8%, 49.4%, and 60.4% across the four datasets, whereas MiT-B5 trained with MIC may demonstrate higher performance with scores of 75.9%, 67.3%, 60.2%, and 70.4% across the four datasets. However, by using system 100, the gap may be reduced to a few mIoU percentages (e.g., 5%) and may even demonstrate similar accuracy (e.g., +0.1%) in the SYN→CS dataset.

Further, as seen in FIG. 3, ResNet-18 trained with DUDA (e.g., methods based on system 100) may achieve improvement over the MIC-based ResNet-101 GTA→CS (e.g., 69.3% mIoU for DUDAMIC ResNet-18 and 64.2% mIoU for MIC ResNet-101). This again highlights the effectiveness of DUDA (e.g., methods based on system 100).

The performance of DUDA (e.g., methods based on system 100) may be clear in DeepLab-V2 models. For example, DUDAMIC improves MiT-B0 by 12.2% mIoU and ResNet-101 by 9.3% mIoU compared to other methods that are not based on system 100 (e.g., MIC). This may further indicate the methods based on system 100 may be effective in both Transformer-based and ResNet-based models. For example, there may be large performance gap in the teacher (MiT-B5) and ResNet models, which methods based on system 100 may reduce.

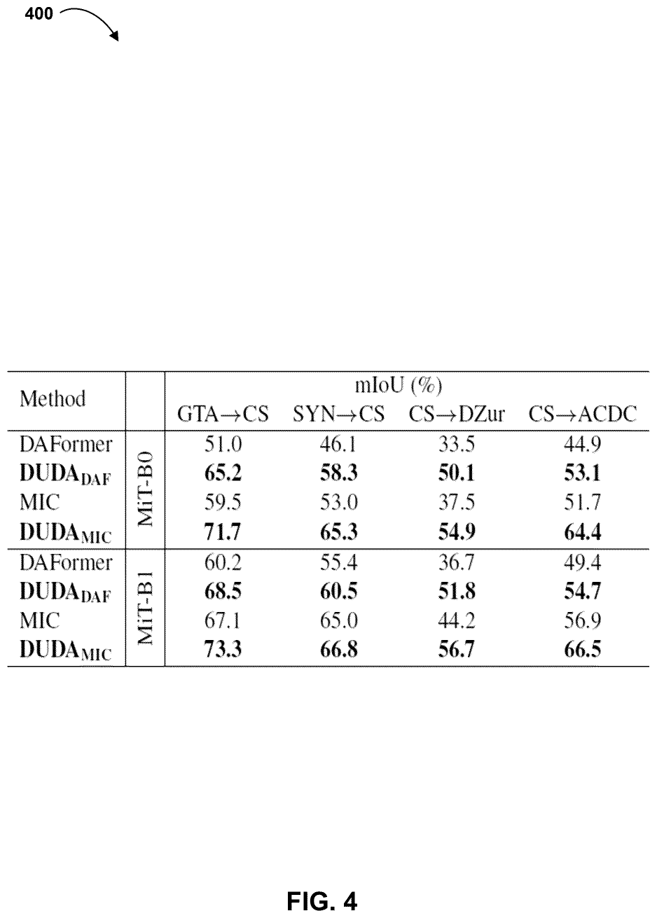

FIG. 4 depicts a comparison table 400, in accordance with example embodiments. Table 400 may be generated based on system 100.

In some embodiments, coupling system 100 with MIC, denoted as “DUDAMIC,” and coupling system 100 with DAFormer, denoted as “DUDADAF,” may highlight the applicability and effectiveness of system 100. In some embodiments, on the GTA→CS dataset, DUDADAF and DUDAMIC have stronger performance than other methods (e.g., MIC, DAFormer), measured using mIoU for both the MiT-B0 backbone and the MiT-B1 backbone. These results may suggest that system 100 may be effective for small models and these results may be consistently observed across other datasets as well. In some embodiments, such performance may be due to learning from higher-quality labels and the inconsistency-based balancing strategy described above. Further, the performance may be strong for less frequent classes.

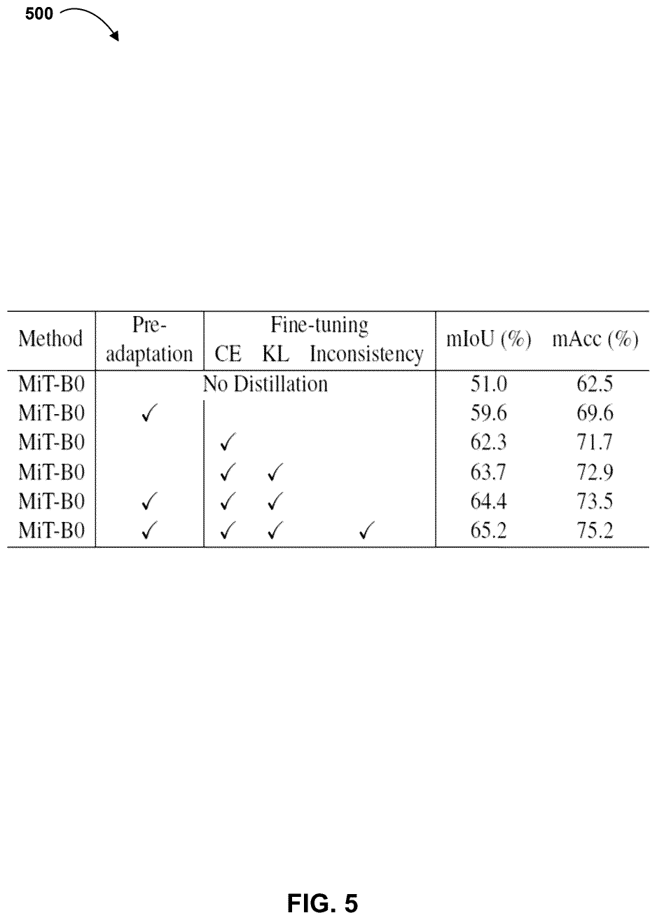

FIG. 5 depicts a table 500 of ablation studies, in accordance with example embodiments. Table 500 may be generated based on system 100. In some embodiments, such ablation studies may use the GTA→CS dataset and may use DAFormer as the base. The results shown in the second row of table 500 may include DAFormer without preadaptation or fine-tuning with cross-entropy, Kullback-Leibler Divergence, and inconsistency-based balanced losses. The results shown in the third row of table 500 may include DAFormer with preadaptation. The results shown in the fourth row of table 500 may include DAFormer without preadaptation but with fine-tuning with cross-entropy. The results shown in the fifth row of table 500 may include DAFormer without preadaptation but with fine-tuning with cross-entropy and Kullback-Leibler Divergence. The results shown in the sixth row of table 500 may include DAFormer with preadaptation and with fine-tuning with cross-entropy and Kullback-Leibler Divergence. The results shown in the seventh row of table 500 may include DAFormer with preadaptation and fine-tuning with cross-entropy, Kullback-Leibler Divergence, and inconsistency-based balanced losses. In table 500, all models may include MiT-B0 models.

In some embodiments, the use of cross-entropy loss may improve accuracy more than use of preadaptation, use of Kullback-Leibler Divergence loss, or use of inconsistency-based balanced loss. In some embodiments, generating pseudo-labels from first teacher model 114 may be a significant driver of the performance of first student model 108. In some embodiments, preadaptation may be important because KD fine-tuning may struggle with large capacity differences between teacher models and student models. In some embodiments, pre-adaptation may improve performance by facilitating the progressive adaptation of first student model 108. In some embodiments, fine-tuning may boost performance of first student model 108 by using matured pseudo-labels from well-trained teacher models (e.g., first teacher model 114) and inconsistency weighting to prioritize underperforming classes. In some embodiments, incorporating pre-adaptation stage may enhance the KD process.

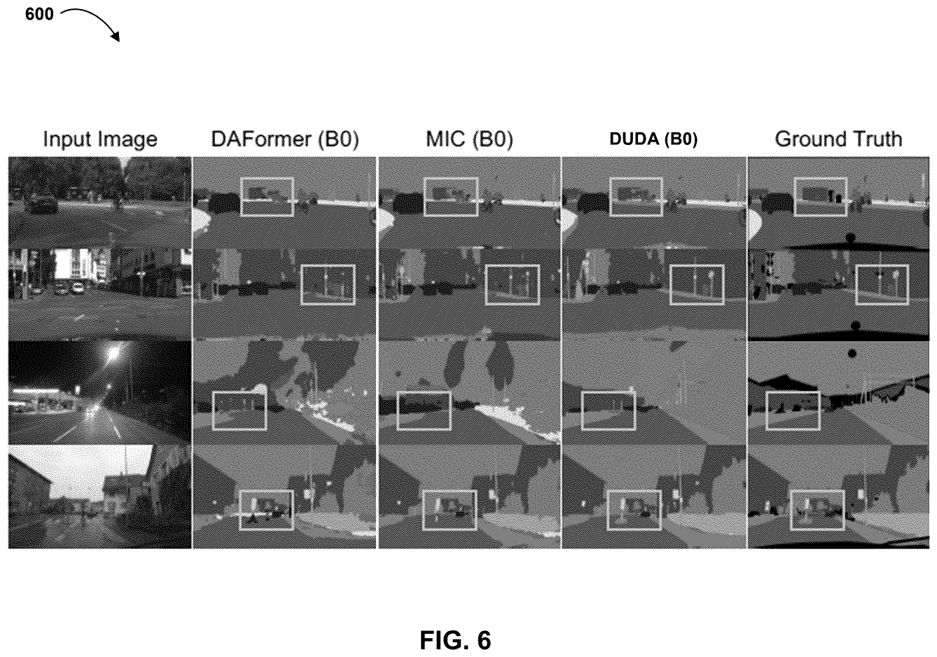

FIG. 6 depicts qualitative segmentation results 600, in accordance with example embodiments. Qualitative segmentation results 600 may be generated based on system 100.

The first row of qualitative segmentation results 600 depicts the results of using different methods on the GTA→CS dataset. The second row of qualitative segmentation results 600 depicts the results of using different methods on the SYN→CS dataset. The third row of qualitative segmentation results 600 depicts the results of using different methods on the CS→DZur dataset. The fourth row of qualitative segmentation results 600 depicts the results of using different methods on the CS→ACDC dataset. Squares within qualitative segmentation results 600 may highlight regions where segmentation results differ across methods.

Qualitative segmentation results 600 displays predictions from MiT-B0 models trained by DUDAMIC, DAFormer, and MIC. In some embodiments, DUDAMIC may accurately predict classes such as sitting persons, sidewalks, sidewalks and/or persons in conditions that include nighttime and rain. In some embodiments, such as those described with respect to FAMDA below, incorporating additional guidance (e.g., depth cues, vision-language model assistance) may improve the performance of first student model 108.

As seen in FIG. 6, DUDA (e.g., methods based on system 100) may accurately predicts sitting persons, sidewalks, and persons, better than methods that are not based on system 100 (e.g., DAFormer and MIC) that may produce unstable predictions. For example, after CS→DZur adaptation, DAFormer may fail to segment the sidewalk appropriately and MIC may incorrectly predicts many cars near the gas station. As another example, in a rainy image after CS→ACDC adaptation, both DAFormer and MIC may fail to classify the small island of the sidewalk, whereas methods based on system 100 may succeed.

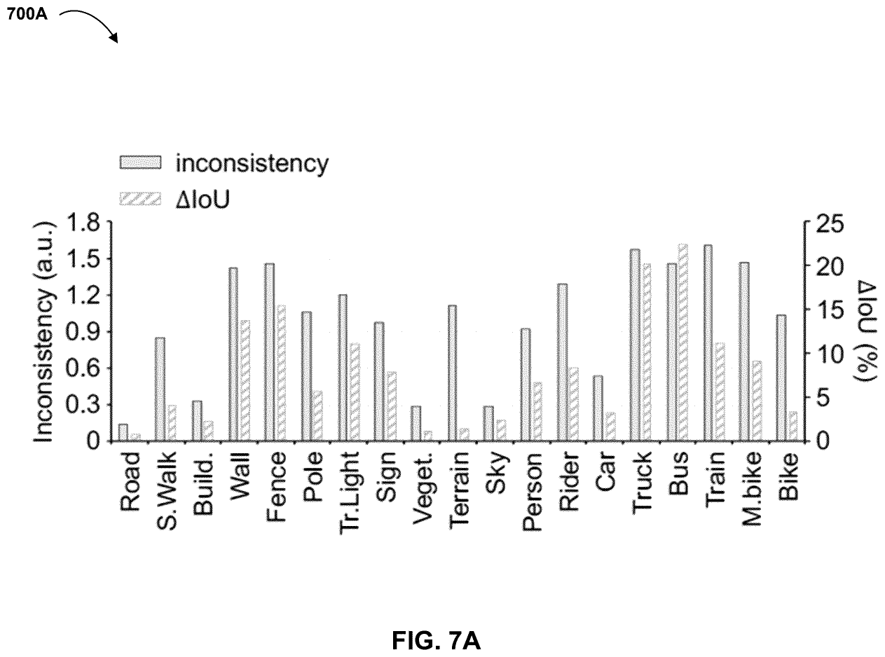

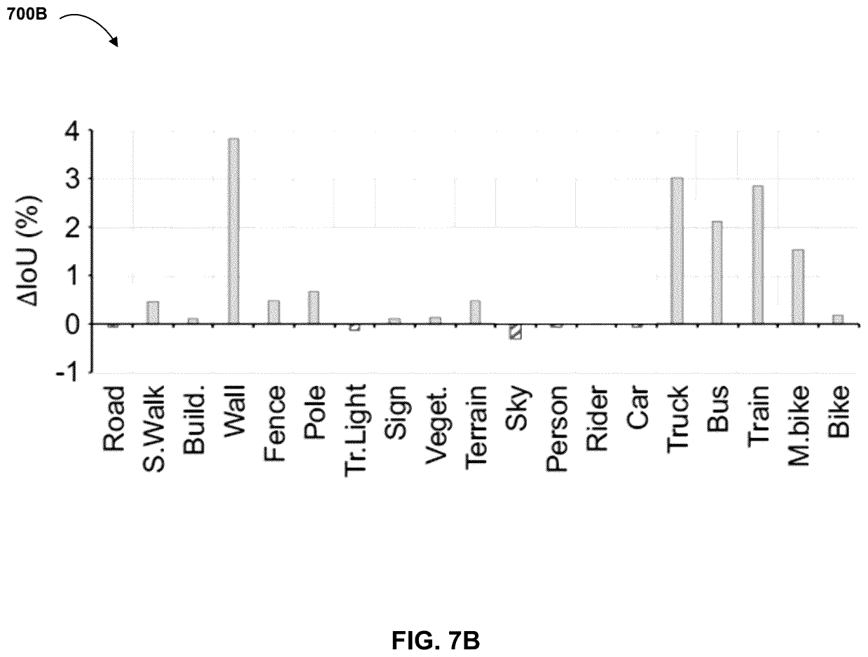

FIG. 7A depicts a graph 700A of class-wise inconsistency changes, in accordance with example embodiments. Graph 700A may be generated based on system 100. Graph 700A may be based on the class-wise inconsistency and accuracy changes resulting from inconsistency-based loss balancing on the GTA→CS dataset. Graph 700A may include a comparison of class-wise true intersection over the union (IoU) disparity and the normalized inconsistency, I′, between first teacher model 114, which may be modeled using MiT-B5, and first student model 108, which may be modeled using MiT-B0, after the pre-adaptation by DUDADAF.

In some embodiments, the inconsistency measure described above may be computed based on pseudo-labels, which may mean that the reliability of the inconsistency measure may be based on the quality of these labels. For example, differences between pseudo-labels and true labels may result in low accuracy values for both first student model 108 and first teacher model 114, even with the high inconsistency.

In some embodiments, increasing the importance of the Kullback-Leibler Divergence may improve the performance of first student model 108 and/or first teacher model 114 for less commonly occurring classes and/or class for which first student model 108 and/or first teacher model 114 have poor performance.

In some embodiments, the inconsistency measure described above may approximately identify underperforming classes. For example, the inconsistency measure may be regarded as the normalized IoU measured on pseudo-labels for the class c during the pre-adaptation.

FIG. 7B depicts a graph 700B of class-wise accuracy changes, in accordance with example embodiments. Graph 700B may be generated based on system 100. Graph 700B depicts the accuracy difference between first student model 108 after fine-tuning with the loss balancing described above and first student model 108 after fine-tuning without the loss balancing described above. In both cases, the inconsistency distribution may be leveraged for training.

In some embodiments, the balanced loss may enhance the accuracy of classes with high inconsistency.

In some embodiments, experiments on four different UDA benchmarks may indicate that the performance of lightweight models may be close to that of heavyweight models. In such embodiments, this may enhance efficiency and flexibility of lightweight models, such as when employing lightweight models on devices that may be resource constrained. In some embodiments, system 100 may be model-agnostic and may be employed in a heterogeneous setting where CNN-based models may be adapted from transformer-based models.

### FAMDA

### Method Description

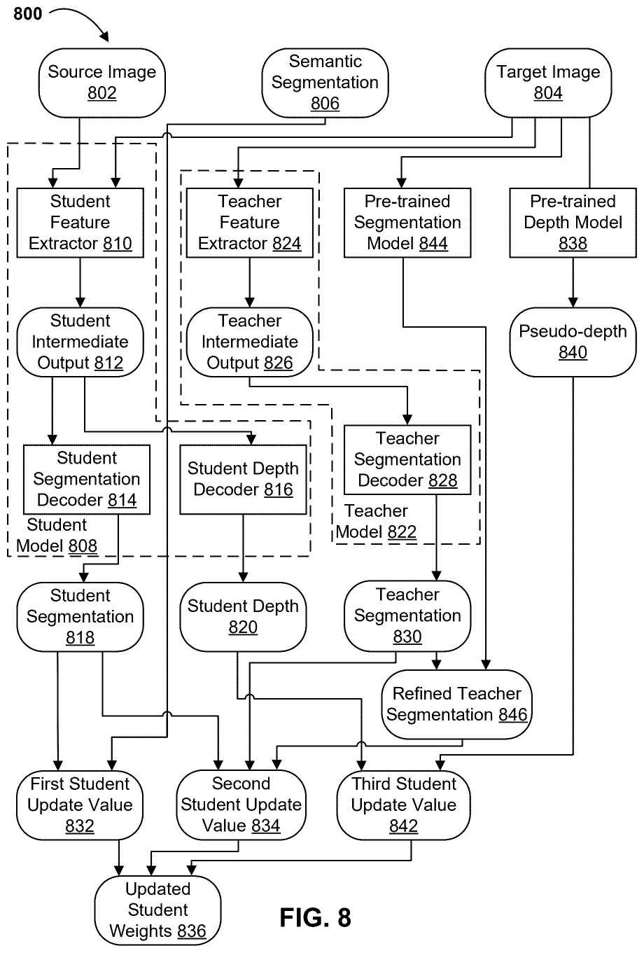

FIG. 8 depicts a system 800, in accordance with example embodiments. As depicted in FIG. 8, system 800 may include student model 808, teacher model 822, pre-trained depth model 838, and pre-trained segmentation model 844. In some embodiments, student model 808 may include first student model 108 and/or second student model 126. In some embodiments, teacher model 822 may include first teacher model 114.

In some embodiments, student model 808 may receive source image 802 and/or target image 804. In some embodiments, source image 802 may include source image 102. In some embodiments, target image 804 may include target image 104. In some embodiments, source image 802 may be one of a plurality of source image 802. Similarly, in some embodiments, target image 804 may be one of a plurality of target image 804. In some embodiments, source image 802 may be one of the plurality of target image 804. Similarly, in some embodiments, target image 804 may be one of the plurality of source image 802.

In some embodiments, semantic segmentation 806 may correspond to source image 802. Semantic segmentation 806 may include semantic segmentation 106.

In some embodiments, source image 802 and/or target image 804 may be received by student model 808 and/or teacher model 822.

As used herein, source image 802 may be represented mathematically as x_{src}, target image 804 may be represented mathematically as x_{tgt}, semantic segmentation 806 may be represented mathematically as y_{src}, student model 808 may be represented mathematically as

$${f}_{θ}^{( student )} ,$$

and teacher model 822 may be represented mathematically as

$${f}_{θ}^{( teacher )} .$$

In some embodiments, based on receiving source image 802 and/or target image 804, student model 808 may generate student segmentation 818 and/or student depth 820. Similarly, based on receiving source image 802 and/or target image 804, teacher model 822 may generate teacher segmentation 830.

In some embodiments, system 800 may be used for multi-task dense prediction. In some embodiments, system 800 may improve pixel-wise predictions on a target domain of images (e.g., target image 804) without access to labels associated with those images. In some embodiments, such predictions may be of a semantic segmentation and/or a depth estimation. It should be noted that, though the subsequent discussion focuses on the tasks of determining a semantic segmentation and/or a depth estimation of images in the target domain, the methods and systems described herein (e.g., system 800) may be applicable to other tasks as well or instead. In some embodiments, these tasks may include the determination of saliency, the detection of boundaries, the determination of the presence/absence of objects, the estimation of normal angles, and other single image-based tasks.

In some embodiments, student model 808 and/or teacher model 822 may include a shared backbone and a different decoder for each task. For example, student model 808 may include student feature extractor 810, student segmentation decoder 814, and student depth decoder 816. In some embodiments, student feature extractor 810 may receive source image 802 and/or target image 804. In some embodiments, based on receiving source image 802 and/or target image 804, student feature extractor 810 may generate student intermediate output 812. In some embodiments, student segmentation decoder 814 and student depth decoder 816 may obtain student intermediate output 812 from student feature extractor 810. In some embodiments, student segmentation decoder 814 may generate student segmentation 818 based on student intermediate output 812. Similarly, in some embodiments, student depth decoder 816 may generate student depth 820 based on student intermediate output 812.

In some embodiments, student model 808 and/or teacher model 822 may have one decoder. For example, teacher model 822 may include teacher feature extractor 824 and teacher segmentation decoder 828.

In some embodiments, teacher feature extractor 824 may receive source image 802 and/or target image 804. In some embodiments, based on receiving source image 802 and/or target image 804, teacher feature extractor 824 may generate teacher intermediate output 826. In some embodiments, teacher segmentation decoder 828 may obtain teacher intermediate output 826 from teacher feature extractor 824. In some embodiments, teacher segmentation decoder 828 may generate teacher segmentation 830 based on teacher intermediate output 826.

In some embodiments, as described above, pseudo-labels may be used to update student model 808 and/or teacher model 822. In some embodiments, the quality of these pseudo-labels (e.g., the accuracy with which the pseudo-labels approximate true labels) may affect adaptation performance. In some embodiments, the quality of the pseudo-labels may change based on the size of student model 808 and/or teacher model 822. For example, a lightweight model (e.g., a model with a relatively small number of parameters) may be paired with a weak teacher model that may lack sufficient generalization capability. One way to address this issue may be by using the strong zero-shot performance of previously trained models (e.g., VFMs such as pre-trained segmentation model 844 and/or pre-trained depth model 838). Such models may improve performance without the need for complex heuristics to refine pseudo-labels. For example, VFMs may provide high-quality supervision either by directly generating pseudo-labels or by refining those produced by another model (e.g., teacher model 822).

In some embodiments, pre-trained depth model 838 (e.g., a DAM) may be used to generate high-quality pseudo-depth maps that are not based on outputs of either teacher model 822 or student model 808. For example, based on the interaction between target image 804 and pre-trained depth model 838, pre-trained depth model 838 may generate pseudo-depth 840. As used herein, pseudo-depth 840 may be represented mathematically as ydep,T. In some embodiments, pseudo-depth 840 may be used to refine the output of student depth decoder 816. The use of pre-trained depth model 838 to generate pseudo-depth 840 may enable teacher model 822 and/or student model 808 to benefit from techniques developed for semantic segmentation and depth supervision. In some embodiments, pre-trained depth model 838 may provide accurate pseudo-depth maps (e.g., a plurality of pseudo-depth 840) that do not use source supervision. Doing so may facilitate applicability of system 800 when ground-truth depth values are unavailable. In some embodiments, pre-trained depth model 838 may generate pseudo-depth 840 via a single forward pass rather than multiple iterative steps.

In some embodiments, pre-trained depth model 838 may be pretrained on large-scale pseudo-labeled depth datasets. Based on this training, pre-trained depth model 838 may be used for generalization across diverse unseen environments without task-specific fine-tuning. In some embodiments, pre-trained depth model 838 may also include a transformer backbone, which may involve computational and memory costs during inference.

In some embodiments, student model 808 and/or teacher model 822 may be updated via backpropagation.

In some embodiments, pre-trained segmentation model 844 (e.g., a SAM) may not directly produce semantically labeled predictions but may collaborate with teacher model 822. For example, based on the interaction between target image 804 and pre-trained segmentation model 844, pre-trained segmentation model 844 may generate an output (e.g., masks) that may be used to refine teacher segmentation 830 and thereby generate refined teacher segmentation 846.

In some embodiments, pre-trained segmentation model 844 may produce segmentation masks that delineate object boundaries. In other embodiments, pre-trained segmentation model 844 may also generate semantic labels corresponding to target image 804. In some embodiments, pre-trained segmentation model 844 may produce segmentation masks offline and these masks may be cached for later use in system 800. Doing so may reduce the latency of system 800.

In some embodiments, the cached masks may be used to refine teacher segmentation 830 to produce refined teacher segmentation 846. In some embodiments, such refinement may be through majority voting (e.g., each mask is assigned the class label most frequently predicted by teacher model 822 within the region corresponding to the mask). Doing so may mitigate uncertain or inconsistent predictions from teacher model 822, which may effectively transfer knowledge from pre-trained segmentation model 844 to teacher model 822. In some embodiments, student model 808 may benefit from refined teacher segmentation 846, such as by improving object boundary predictions when student model 808 is a lightweight model. In some embodiments, semantic segmentation 806 may be used for supervision.

In some embodiments, pre-trained segmentation model 844 may be trained over many (e.g., over one billion) masks. In some embodiments, pre-trained segmentation model 844 may formulate a segmentation as a promptable task (e.g., using points, boxes, and/or masks as inputs). In some embodiments, pre-trained segmentation model 844 may exhibit strong zero-shot performance in unseen domains.

In some embodiments, pre-trained segmentation model 844 may include a ViT-H backbone, which may include approximately 600 million parameters and may require hundreds of GFLOPs per image. In some embodiments, the per-image inference of pre-trained segmentation model 844 may be tens of seconds.

In some embodiments, combining domain-adaptive models with VFMs may offer an efficient and powerful way to enhance pseudo-label quality. In some embodiments, this VFM-driven guidance may be agnostic to the underlying model of teacher model 822 or student model 808. This may facilitate the consistent provision of high-quality teaching signals, such as for lightweight architectures.

In some embodiments, model parameters (e.g., weights) corresponding to student model 808 and/or teacher model 822 may change (e.g., be updated) over time (e.g., across iterations, across images, across values of hyperparameters). For example, student model 808 may have a first set of model parameters at one iteration and a second set of model parameters at a second iteration. One process by which student model 808 and/or teacher model 822 may change may be referred to as “self-training.” Such self-training may include the use of predictions from student model 808 and/or teacher model 822 based on target image 804 as a pseudo-label to iteratively refine the training of student model 808 and/or teacher model 822. Doing so may be an efficient and effective way to leverage target image 804.

In some embodiments, teacher model 822 may provide supervision to guide student model 808. For example, in some embodiments, student model 808 and teacher model 822 may be instances of the same function (e.g., for an iteration t,

$${f}_{θ}^{( student )}$$

may be the same as

$${f}_{θ}^{( teacher )} ) .$$

In some embodiments, model parameters corresponding to teacher model 822 may not be updated directly (e.g., via gradient descent). In such embodiments, model parameters corresponding to teacher model 822, which may be represented mathematically as θ^{(teacher)}, may be updated via an EMA of model parameters corresponding to student model 808, which may be represented mathematically as θ^{(student)}. For example, model parameters corresponding to teacher model 822 may be updated according to the following equation:

$${θ}^{( teacher )} ( t ) = α \cdot {θ}^{( teacher )} ( t - 1 ) + ( 1 - α ) \cdot {θ}^{( student )} ( t - 1 ) , \qquad ( Eqn . 16 )$$

where α is a constant (e.g., a smoothing factor) that may have a value withing the range of zero and one. In some embodiments, a larger value of α may place more weight on previous values of teacher model 822, which may yield a more stable model. In some embodiments, a smaller value of a may facilitate rapid adaptation to recent values from student model 808. Updating teacher model 822 in this manner may produce more reliable pseudo-labels, which may reduce the risk of propagating noisy predictions and may stabilize training of student model 808 and/or teacher model 822. Such updates may be useful when target image 804 does not have ground-truth annotations.

In some embodiments, model parameters corresponding to student feature extractor 810 may be used to update model parameters corresponding to teacher feature extractor 824 (e.g., via Eqn. 16). In some embodiments, model parameters corresponding to student segmentation decoder 814 may be used to updated model parameters corresponding to teacher segmentation decoder 828 (e.g., via Eqn. 16).

In some embodiments, model parameters corresponding to student model 808 may be updated based on one or more loss functions or “losses.” For example, one or more loss functions may be used to generate updated student weights 836 that corresponds to student model 808. One or more of these loss functions may be based on student segmentation 818 and semantic segmentation 806. For example, one or more of these loss functions may be based on the cross-entropy between student segmentation 818 and semantic segmentation 806, which may be represented mathematically as [symbol] . In some embodiments, such a loss function may penalize classification errors on labeled images (e.g., a plurality of source image 802). In some embodiments, this loss function may be expressed using the following mathematical expression

$${ℒ}_{CE ; S} = - {\sum }_{i = 1}^{H * W} {\sum }_{c = 1}^{C} {y}_{src}^{i , c} * log ( {{f}_{θ}^{( student ; seg )} ( {x}_{src} )}^{i , c} ) , \qquad ( Eqn . 17 )$$

where

$${y}_{src}^{i , c}$$

is the cth class of the ith pixel in semantic segmentation 806,

$${f}_{θ}^{( student ; seg )} {( {x}_{src} )}^{i , c}$$

is the cth class of the ith pixel in student segmentation 818, and C is the number of classes corresponding to source image 802 (e.g., 10 classes, 20 classes, 100 classes, 150 classes, 1,000 classes). In some embodiments, first student update value 832 may be based on this loss function.

In some embodiments, one or more loss functions may be based on student segmentation 818, teacher segmentation 830, and/or refined teacher segmentation 846. For example, one or more loss functions may be based on the cross-entropy between student segmentation 818 and teacher segmentation 830 or refined teacher segmentation 846, which may be represented mathematically as [symbol] . In some embodiments, such a loss function may penalize classification errors on pseudo-labeled images (e.g., a plurality of target image 804). In some embodiments, this loss function may be expressed using the following mathematical expression

$${ℒ}_{CE ; T} = - {\sum }_{i = 1}^{H * W} {\sum }_{c = 1}^{C} {{f}_{θ}^{( teacher ; seg )} ( {x}_{tgt} )}^{i , c} * log ( {{f}_{θ}^{( student ; seg )} ( {x}_{tgt} )}^{i , c} ) , \qquad ( Eqn . 18 )$$

where

$${{f}_{θ}^{( teacher ; seg )} ( {x}_{src} )}^{i , c}$$

is the cth class of the ith pixel in teacher segmentation 830 or refined teacher segmentation 846 and

$${{f}_{θ}^{( student ; seg )} ( {x}_{src} )}^{i , c}$$

is the cth class of the ith pixel in student segmentation 818. In some embodiments, second student update value 834 may be based on this loss function.

In some embodiments, one or more of these loss functions may be based on student depth 820 and pseudo-depth 840. For example, one or more loss functions may be based on the root mean squared error (RMSE) between the student depth 820 and pseudo-depth 840 (e.g., median-based scale-and-shift-invariant (SSI) RMSE between the student depth 820 and pseudo-depth 840), which may be represented mathematically as [symbol] . In some embodiments, this loss function may be expressed using the following mathematical expression

$${ℒ}_{RMSE ; T} = RMSE ( SSI ( \tilde{y} ( {x}_{tgt} ) ) , SSI ( {f}_{θ}^{( student ; dep )} ( {x}_{tgt} ) ) ) , \qquad ( Eqn . 19 )$$

where \tilde{y}(x_{tgt}) is pseudo-depth 840,

$${f}_{θ}^{( student ; dep )} ( {x}_{tgt} )$$

is student depth 820, and SSI(·) may be expressed using the following mathematical expression

$$SSI ( y ) = \frac{y - med ( y )}{mean \vert y - med ( y ) \vert} , \qquad ( Eqn . 20 )$$

where med(·) is the median operator and mean(·) is mean operator (e.g., arithmetic mean, geometric mean, harmonic mean). In some embodiments, third student update value 842 may be based on this loss function.

In Eqn. 20, the numerator may center the distribution of the error by subtracting the median and the denominator may normalize the scale of the error. In some embodiments, models may not be inherently scale-aware, which may mean that normalization may facilitate consistent learning across diverse target images.

As stated above, in some embodiments, model parameters corresponding to student model 808 may be updated based on one or more loss functions. In some embodiments, model parameters corresponding to student model 808 may be updated based on a weighted combination of one or more loss functions. For example, model parameters corresponding to student model 808 may be updated based on the following loss function

$${ℒ}_{Total} = {ℒ}_{CE ; S} + {ℒ}_{CE ; T} + β \cdot {ℒ}_{RMSE ; T} , \qquad ( Eqn . 21 )$$

where β is a real number (e.g., 0.1).

In some embodiments, system 800 may be based on DAFormer. In some embodiments, DAFormer may employ one or more data augmentation strategies (e.g., color jitter, cropping, flipping). Using one of more of these data augmentation strategies may facilitate reductions in the distributional gap between source image 802 and target image 804 and may also facilitate mitigation of abrupt changes in input style. In some embodiments, one such data augmentation strategy may be image mixing, in which selected objects in target image 804 are replaced with counterparts from source image 802. Such a strategy may enhance semantic segmentation performance.

In some embodiments, some strategies may be used to generate student segmentation 818 and/or teacher segmentation 830 and not used to generate student depth 820. In other embodiments, some strategies may be used to generate student depth 820 but not used to generate student segmentation 818 and/or teacher segmentation 830.

In some embodiments, system 800 may be applicable across different model architectures (e.g., ResNet-based models, transformer-based models, CNN-based models). For example, student model 808 and/or teacher model 822 may include DeepLab-V2 with ResNet-101, SegFormer with MiT-B5, SegFormer MiT-B0, SegFormer MiT-B1, and/or SegFormer MiT-B2. As another example, student segmentation decoder 814, student depth decoder 816, and/or teacher segmentation decoder 828 may include a DAFormer decoder head and/or a DeepLab-V2 decoder head, instantiated in parallel for each task. In some embodiments, student feature extractor 810 and/or teacher feature extractor 824 may include a DAFormer backbone, which may have a low computational inference costs and balance performance with real-time deployment constraints.

Similarly, pre-trained depth model 838 and pre-trained segmentation model 844 may be based on different model architectures. For example, pre-trained segmentation model 844 may include a ViT-H encoder, while pre-trained depth model 838 may include a ViT-L encoder. In some embodiments, the use of pre-trained segmentation model 844 may involve the generation, by pre-trained segmentation model 844, of masks. For example, such mask generation may include configuring prompts to include 128 points per side, setting the prediction IoU threshold to 0.86, and/or setting the stability score threshold to 0.92.

In some embodiments, system 800 may have high performance in the synthetic-to-real domain adaptation setting. For the synthetic domain (e.g., for source image 802), the Virtual KITTI2 (VK2) dataset, which may include approximately 21,000 images of 1,242 pixels by 375 pixels, and/or the SYN dataset may be used. For the real-world domain (e.g., for target image 804), the CS dataset may be used.

### Experimental Results

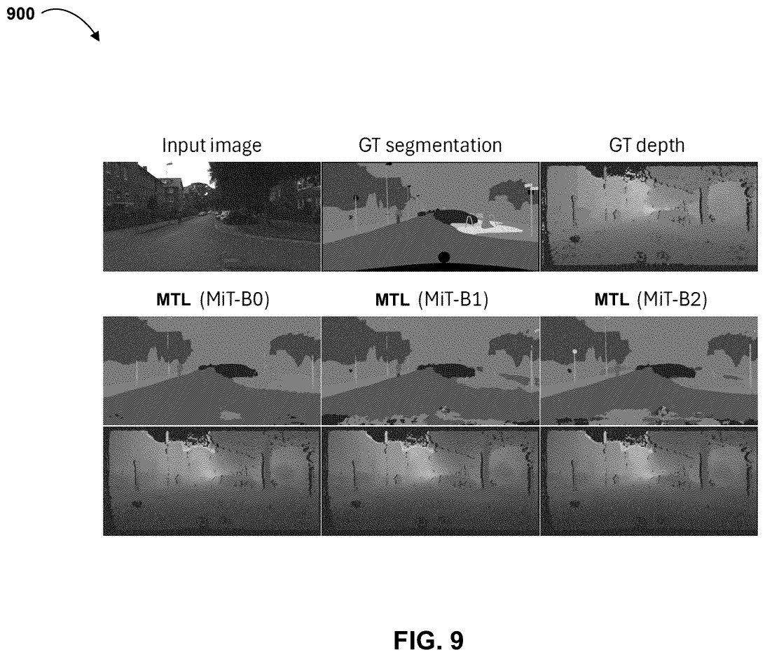

FIG. 9 depicts qualitative segmentation and depth results 900, in accordance with example embodiments. Qualitative segmentation and depth results 900 may be generated using system 800. Qualitative segmentation and depth results 900 may be based on a benchmark dataset (e.g., SYN→CS, VK2→CS). Qualitative segmentation and depth results 900 may be based on lightweight backbones (e.g., MiT-B0, MiT-B1, MiT-B2).

In some embodiments, student model 808, teacher model 822, pre-trained segmentation model 844, and/or pre-trained depth model 838 may be based on adversarial learning, which may involve a discriminator pushing a model toward domain-invariant predictions. In some embodiments, the use of self-training with pixel-level pseudo-labels may provide richer and more informative supervision, which may facilitate student model 808 to achieve stronger cross-domain generalization. In some embodiments, models trained on the target domain (e.g., using target image 804) may yield accurate predictions across tasks and datasets, which may highlight the benefits of using high-quality learning signals. In some embodiments, system 800 may be used to achieve high performance even without employing dedicated decoder designs that may mitigate cross-task interference.

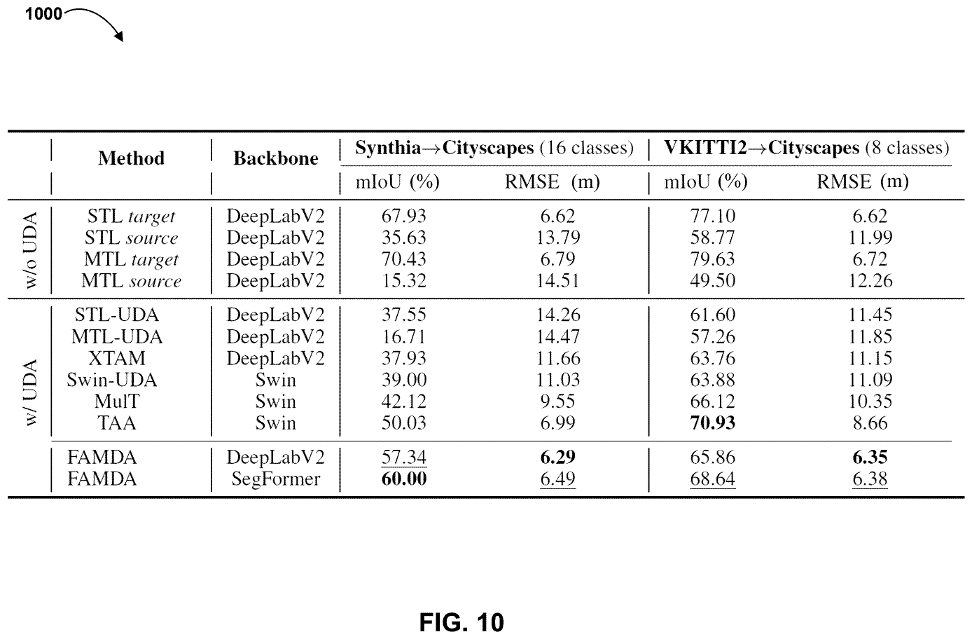

FIG. 10 depicts a comparison table 1000, in accordance with example embodiments. Table 1000 may be generated using system 800. Table 1000 indicates performance in terms of semantic segmentation, in terms of mIoU, and depth estimation, in terms of RMSE, on both the SYN→CS dataset and the VK2→CS datasets.

In some embodiments, RMSE may be computed on depth maps (e.g., student depth 820) after applying median scaling. In some embodiments, RMSE may be evaluated within the range 10⁻³ meters to 80 meters (e.g., pixels outside this range may be excluded using a mask). In some embodiments, after masking, median scaling may be applied to the prediction and/or ground truth depth values. In some embodiments, the median scaling applied to the prediction may be expressed using the following mathematical expression

$${prediction}_{scaled} = prediction \cdot \frac{med ( ground truth )}{med ( protection )} . \qquad ( Eqn . 22 )$$

In some embodiments, RMSE may be calculated based on the median-scaled prediction and ground truth.

As seen in FIG. 10, methods based on system 800 may have better performance than methods not based on system 800 in most cases. This may result from the use of self-training with pixel-level pseudo-labels instead of output-level adversarial learning—where a discriminator pushes the model toward domain-invariant predictions but offers only a coarse, binary signal. Such pseudo-labels may provide richer and more informative supervision, which may enable a student model (e.g., student model 808) to achieve stronger cross-domain generalization than methods not based on system 800.

In some embodiments, a SegFormer backbone may have slightly lower mIoU than TAA in the VK2→CS setting. This gap in performance may result from poor IoU performance on the traffic sign class, representing around 20% of the classes, which may disproportionately reduce the average performance. However, methods based on system 800 may outperform Swin-based baselines on the SYN→CS dataset, underscoring the robustness of methods based on system 800 across architectures and domains.

As seen in FIG. 10, methods based on system 800 that use UDA may be compared to models that are not based on system 800, including STL and MTL trained in a fully supervised manner on either the source or target domain, denoted as “STL source” and “MTL target,” respectively. In some embodiments, models trained directly on the target domain suggest that the architectures may be sufficiently expressive to yield accurate predictions across tasks and datasets. As further seen in FIG. 10, despite not employing dedicated decoder designs to mitigate cross-task interference, methods based on system 800 may outperform other methods.

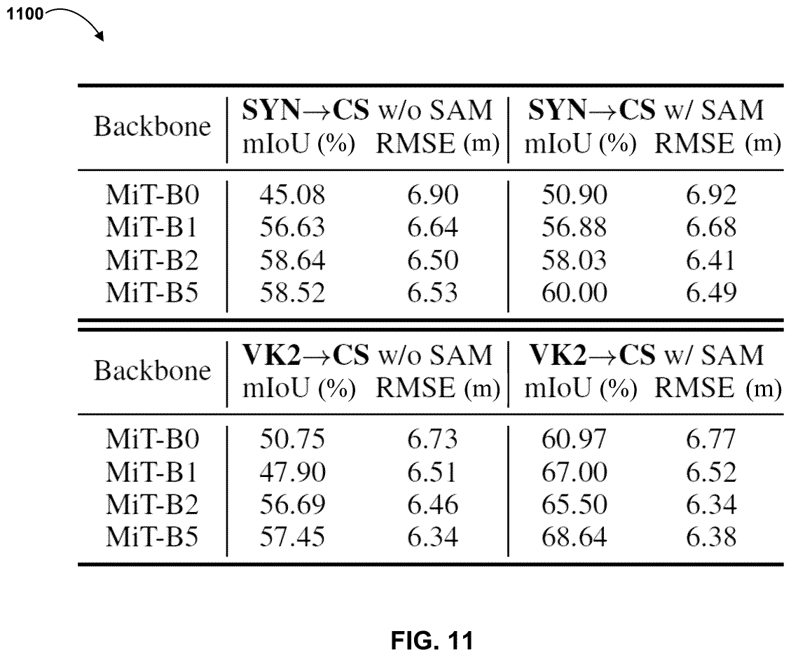

FIG. 11 depicts a comparison table 1100, in accordance with example embodiments. Table 1100 may be generated using system 800.

In some embodiments, the guidance from VFMs (e.g., multiple teachers) may be used as a form of KD. In some embodiments, performance improvements from leveraging VFMs may become pronounced as the size of the model decreases. For example, in SYN→CS, the MiT-B0 backbone may have a 5.8% improvement in mIoU compared with a 1.5% improvement in mIoU for MiTB5. Similarly, in VK2→CS, use of an MiT-B1 may have a 19.1% improvement in mIoU, while the improvement may be 11.2 when using MiT-B5.

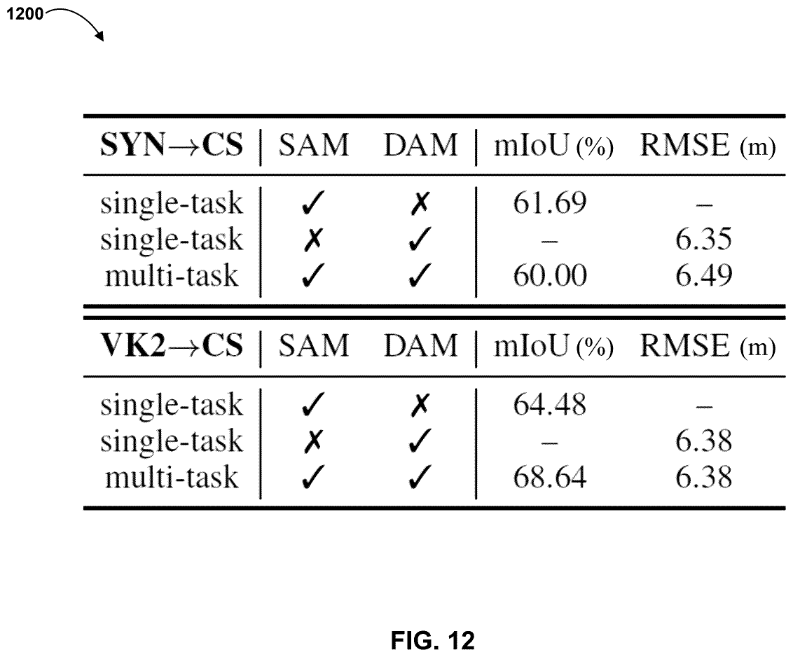

FIG. 12 depicts a comparison table 1200, in accordance with example embodiments. Table 1200 may be generated using system 800.

In some embodiments, student model 808 and/or teacher model 822 may be trained for either semantic segmentation or depth estimation and not both semantic segmentation and depth estimation. In some embodiments, combining VFM-based methods with multi-task decoder designs may amplify one or more benefits of using system 800 (e.g., high performance, consistent performance across tasks and domains).

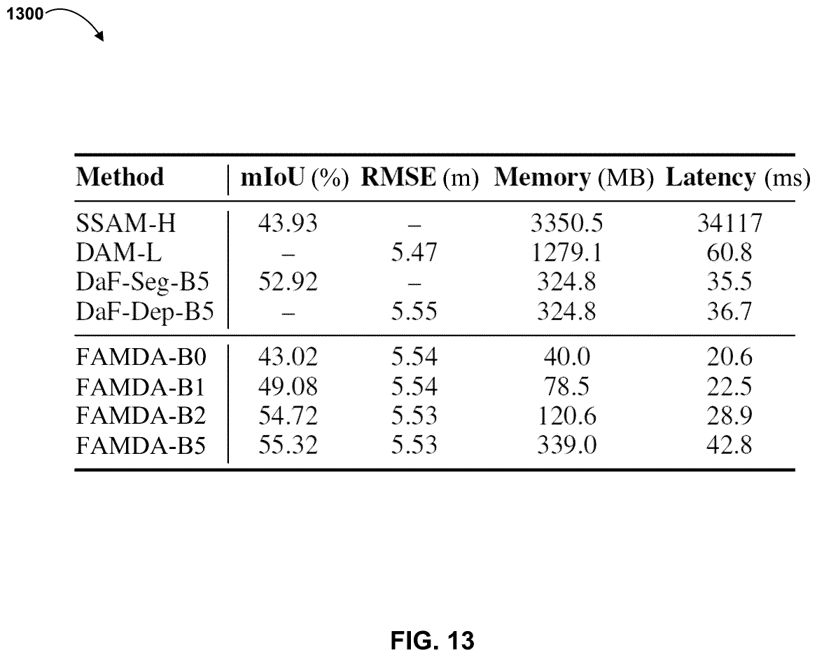

FIG. 13 depicts a comparison table 1300, in accordance with example embodiments. Table 1300 may be generated using system 800.

As stated above, in some embodiments, one or more models in system 800 may be trained for semantic segmentation, referred to as DaF-Seg-B5 in table 1300, and/or depth estimation, referred to as DaF-Dep-B5 in table 1300.

In some embodiments, system 800 may have practical robustness. For example, system 800 may have strong domain transfer performance from CS to a low-light nighttime dataset collected using a low-light camera sensor, which may reflect generalization to the adverse conditions may be faced by deployed robotic systems.

Such a low-light nighttime dataset may be based on a sensor system with a stereo camera that may include two high-resolution low-light-sensitive cameras and may include multiple outdoor nighttime sequences in a semi-urban environment (e.g., around an office campus). The dataset may include two collection phases (e.g., June sequences captured while walking around between 8:30 PM and 10:30 PM, September sequences recorded from a vehicle platform between 7:30 PM and 9:00 PM). The dataset may include temporal and mobility variation, which may provide diverse lighting conditions and scene perspectives for evaluation. In some embodiments, the stereo camera system may be calibrated using a checkerboard method, which may enable image rectification and stereo disparity computation at a resolution of 1,680 pixels by 1,056 pixels. In some embodiments, disparity maps generated using stereo matching methods may serve as a pseudo-ground truth for evaluating depth estimation quality. In some embodiments, the semantic classes for one dataset may overlap with those in the CS dataset, enabling the use of the same class taxonomy and thereby facilitating consistency across evaluation conditions. In some embodiments, some frames may be unlabeled (e.g., 1,000 frames may be unlabeled). In some embodiments, one or more unlabeled frames may be used for training one or more models in system 800 (e.g., student model 808).

In some embodiments, pre-trained segmentation model 844 may include a SAM-H model for the mask branch, combined with a OneFormer Swin-L model pre-trained on the CS dataset as the semantic branch.

In some embodiments, use of a shared backbone (e.g., student feature extractor 810) may reduce memory consumption compared with running separate models for each task.

FIG. 13 highlights that the framework described above with respect to system 800 may provide computational advantages compared with methods that are not based on system 800. For example, the FAMDA-B2 model, which is based on system 800, may have a high performance, with an mIoU of 54.72 and an RMSE of 5.53, with only 120.6-megabyte (MB) memory footprint and 28.9 ms latency. This model is more efficient than foundation models like SSAM-H, which may have a memory footprint of 3350.5 MB and a latency of 34117 ms, and DAM-L, which may have a memory footprint of 1279.1 MB and a latency of 60.8 ms. Furthermore, the FAMDA-B2 model may provide near real-time operation at 7 Hz on an NVIDIA® JETSON NANOR embedded platform, which suggests that models based on system 800 may be applicable in mobile robotics. Further, the scalability across backbone sizes (e.g., FAMDA-B0 to FAMDA-B5) may facilitate flexible deployment based on computational constraints as the lightweight B0 variant (e.g., FAMDA-B0) may achieve reasonable performance (e.g., an mIoU of 43.02), while using relatively small amount of resources (e.g., a 40.0 MB memory footprint and latency of 20.6 ms).

In some embodiments, scalability of system 800 across backbone sizes (e.g., B0 to B5) may facilitate flexible deployment and limited computational constraints.

In some embodiments, the performance of student model 808 and/or teacher model 822 may be better than the performance of pre-trained segmentation model 844, and/or pre-trained depth model 838.

As seen in Table 13, models based on system 800 may achieve superior performance and efficiency compared to both vision foundation models and single-task UDA methods. For example, models based on system 800 may have the best semantic segmentation performance, with FAMDA-B5 having an mIoU of 55.32 and FAMDA-B2 model having mIoU of 54.72, outperforming the single-task DaF-Seg-B5 model (mIoU of 52.92) and the SSAM-H segmentation foundation model (mIoU of 43.93), while simultaneously providing depth estimation capabilities. In depth estimation, models based on system 800 may achieve RMSE values around 5.53, which may be comparable to the performance achieved by the specialized depth foundation model DAM-L (RMSE of 5.47) and the single-task UDA model DaF-Dep (RMSE 5.55).

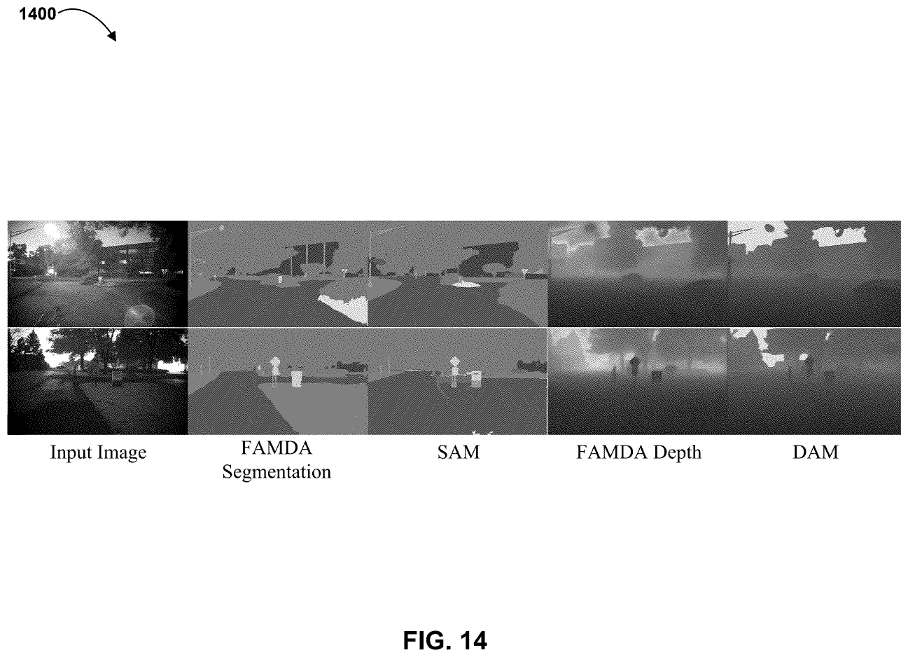

FIG. 14 depicts qualitative segmentation and depth results 1400, in accordance with example embodiments. Qualitative segmentation and depth results 1400 may be generated using system 800.

In some embodiments, the results from student depth 820 may be similar to or better than the results from pre-trained depth model 838. In some embodiments, the results from student segmentation 818 may be similar to or better than the results from pre-trained segmentation model 844. Specifically, for semantic segmentation, models based on system 800 may perform better than that of SAM. This may be because SAM may miss many minority classes (e.g., traffic lights, people).

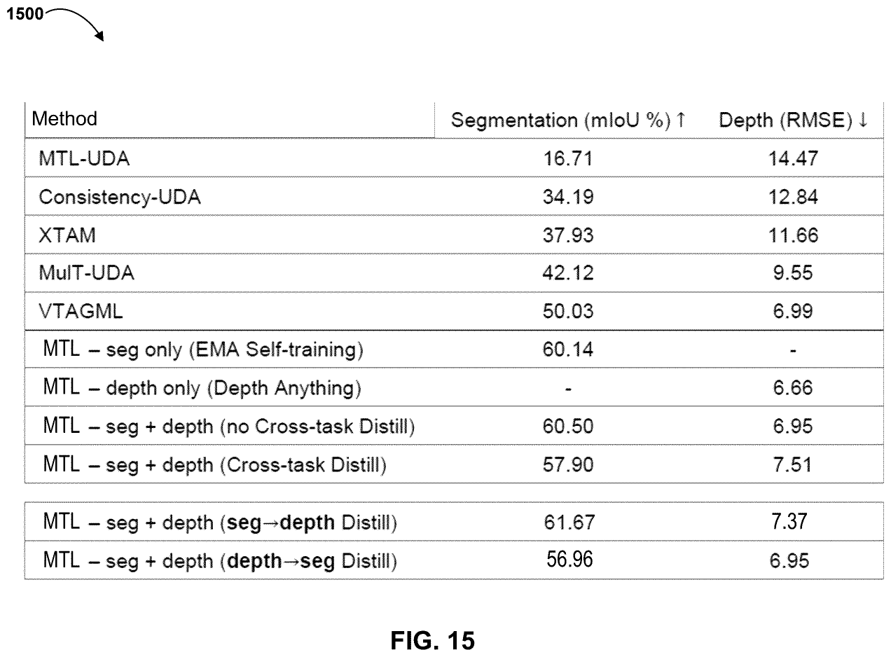

FIG. 15 depicts a comparison table 1500, in accordance with example embodiments. Table 1500 may be generated using system 800.

As depicted in FIG. 15, methods based on system 800 (e.g., a DAFormer-based MTL with no distillation) may outperform methods not based on system 800.

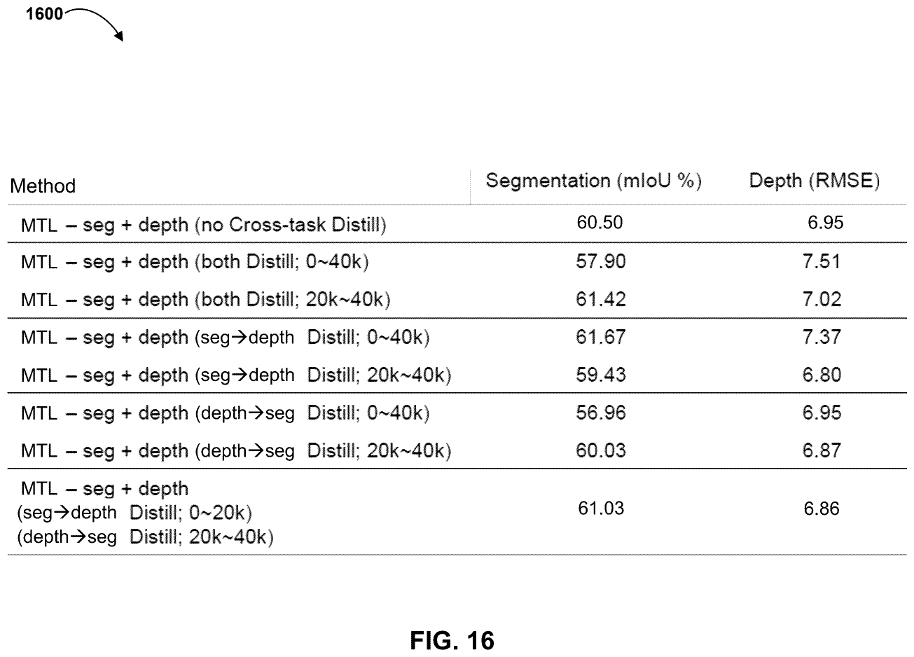

FIG. 16 depicts a comparison table 1600, in accordance with example embodiments. Table 1600 may be generated using system 800.

As depicted in FIG. 16, the use of seg→depth distillation in later stages (e.g., iterations 20,000 to 40,000) may improve depth estimation. Further, the use of seg→depth distillation in early stages (e.g., iterations 0 to 20,000) may improve segmentation estimation. Moreover, the use of depth→seg distillation in later stages may improves depth estimation. In some embodiments, the performance of methods based on system 800 may be improved by using seg→depth distillation between iterations 0 and 20,00 and using depth→seg afterwards (e.g., iterations 20,000 to 40,000).

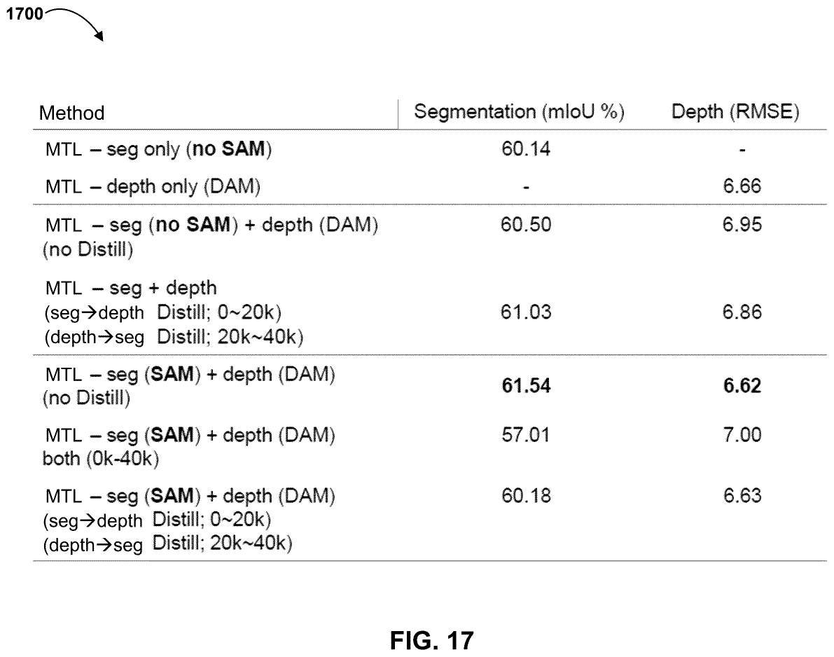

FIG. 17 depicts a comparison table 1700, in accordance with example embodiments. Table 1700 may be generated using system 800.

As depicted in FIG. 17, in models based on system 800, the SAM (e.g., pre-trained segmentation model 844) and the DAM (e.g., pre-trained depth model 838) may enhance the performance even without cross-task distillation. Further, in some embodiments, the use of a SAM may make pseudo supervision for segmentation more stable.

### Example Machine Learning Models

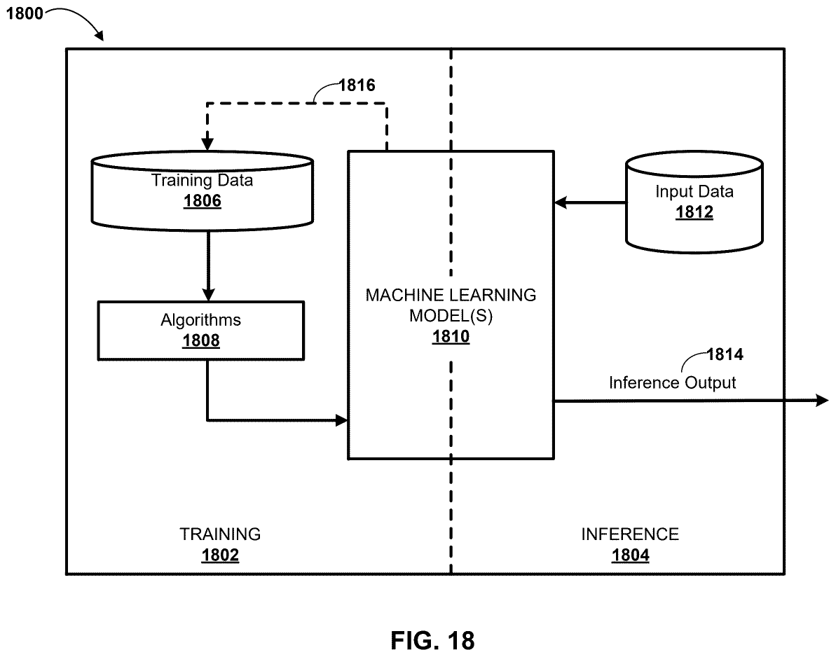

FIG. 18 depicts a block diagram 1800 of training and inference phases for an example machine learning model, in accordance with example embodiments. As described herein, one or more machine learning models may be trained and deployed to perform the tasks. For example, pre-trained segmentation model 844 may include a trained classifier. Trained models may also be used to determine first source segmentation 110, first target segmentation 112, second target segmentation 116, third target segmentation 120, third source segmentation 128, fourth target segmentation 130, student segmentation 818, student depth 820, teacher segmentation 830, pseudo-depth 840.

Block diagram 1800 includes training phase 1802 and inference phase 1804. Machine learning models 1810 may be trained during the training phase 1802 by using training data 1806. In some embodiments, machine learning models may be trained by utilizing one or more machine learning models 1810 that are applied to training data 1806 to recognize patterns in input data 1812 and output inference output 1814. Training data 1806, the one or more algorithms 1808, or both, may depend on a particular machine learning model, its expected functionality, a desired precision, a desired efficiency, a desired accuracy, available computing resources, and so forth. During the inference phase 1804, trained versions of machine learning models 1810 receive input data 1812 and generate predictions or an inference output 1814 about input data 1812.

Algorithms 1808 may include, but are not limited to artificial neural networks (e.g., convolutional neural networks, recurrent neural networks, a Bayesian network, a hidden Markov model, a Markov decision process, a logistic regression function, a support vector machine, a statistical machine learning algorithm, and/or a heuristic machine learning system). Algorithms 1808 may involve supervised, unsupervised, semi-supervised, and/or reinforcement learning techniques. Machine learning models 1810 may involve natural language processing (NLP), natural language understanding (NLU), natural language grammar (NLG), or any combination thereof. In some embodiments, machine learning models 1810 may be updated based on the inference phase 1804 and training data 1806 may be updated via feedback loop 1816.

In some embodiments, machine learning models 1810 and/or algorithms 1808 may be located within one computing device, or in a shared computing environment. In some embodiments, machine learning models 1810 and/or algorithms 1808 may be a part of a distributed computing architecture, such as one or more cloud servers. Also, for example, machine learning models 1810 and/or algorithms 1808 may be located within an organization. In some embodiments, the training phase 1802 of the one or more machine learning models 1810 may be performed at a computing device that is different from a computing device where inference phase 1804 is performed. Also, for example, input data 1812 may be received at a first computing device, and provided to a second computing device that houses trained versions of machine learning models 1810. The second computing device may then apply machine learning models 1810 to input data 1812 and generate inference output 1814. Subsequently, inference output 1814 may be provided to the first computing device.

### Example Methods

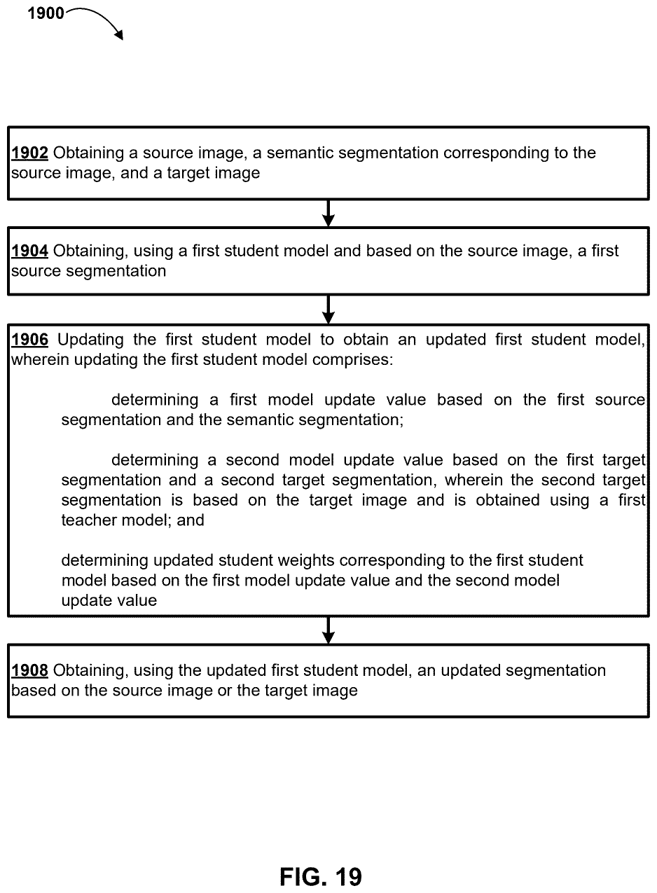

FIG. 19 depicts a flowchart diagram illustrating method 1900, in accordance with example embodiments. In some embodiments, method 1900 may be performed by a system (e.g., system 100 shown and described with reference to FIG. 1, system 800 shown and described in reference to FIG. 8).

At block 1902, method 1900 may include obtaining a source image, a semantic segmentation corresponding to the source image, and a target image.

At block 1904, method 1900 may include obtaining, using a first student model and based on the source image, a first source segmentation.

At block 1906, method 1900 may include updating the first student model to obtain an updated first student model, wherein updating the first student model comprises: determining a first model update value based on the first source segmentation and the semantic segmentation; determining a second model update value based on the first target segmentation and a second target segmentation, wherein the second target segmentation is based on the target image and is obtained using a first teacher model; and determining updated student weights corresponding to the first student model based on the first model update value and the second model update value.

At block 1908, method 1900 may include obtaining, using the updated first student model, an updated segmentation based on the source image or the target image.

In some embodiments, method 1900 may further include updating the first teacher model to obtain an updated first teacher model. In some embodiments, updating the first teacher model may include obtaining, using a second student model and based on the source image, a third source segmentation. In some embodiments, updating the first teacher model may include obtaining, using the first teacher model and based on the target image, a third target segmentation. In some embodiments, updating the first teacher model may include obtaining, using the second student model and based on the target image, a fourth target segmentation. In some embodiments, updating the first teacher model may include determining a third model update value based on the third source segmentation and the semantic segmentation. In some embodiments, updating the first teacher model may include determining a fourth model update value based on the third target segmentation and the fourth target segmentation. In some embodiments, updating the first teacher model may include determining updated teacher weights corresponding to the first teacher model based on the third model update value and the fourth model update value.

In some embodiments, updating the first teacher model may include determining a moving average of the third model update value, the fourth model update value, and weights corresponding to the first teacher model.

In some embodiments, the first student model may include a convolutional neural network. In some embodiments, the first teacher model and the second student model each may include a respective transformer model.

In some embodiments, the first model update value may be based on cross-entropy between the first source segmentation and the semantic segmentation. In some embodiments, the second model update value may be based on at least one of cross-entropy or Kullback-Leibler Divergence between the first target segmentation and the second target segmentation.

In some embodiments, the second model update value may be further based on a similarity between the first target segmentation and the second target segmentation.

In some embodiments, the second model update value may be further based on an inconsistency between prediction results in the first target segmentation and prediction results in the second target segmentation.

In some embodiments, determining the updated student weights may be based on a weighted combination of the first model update value and the second model update value.

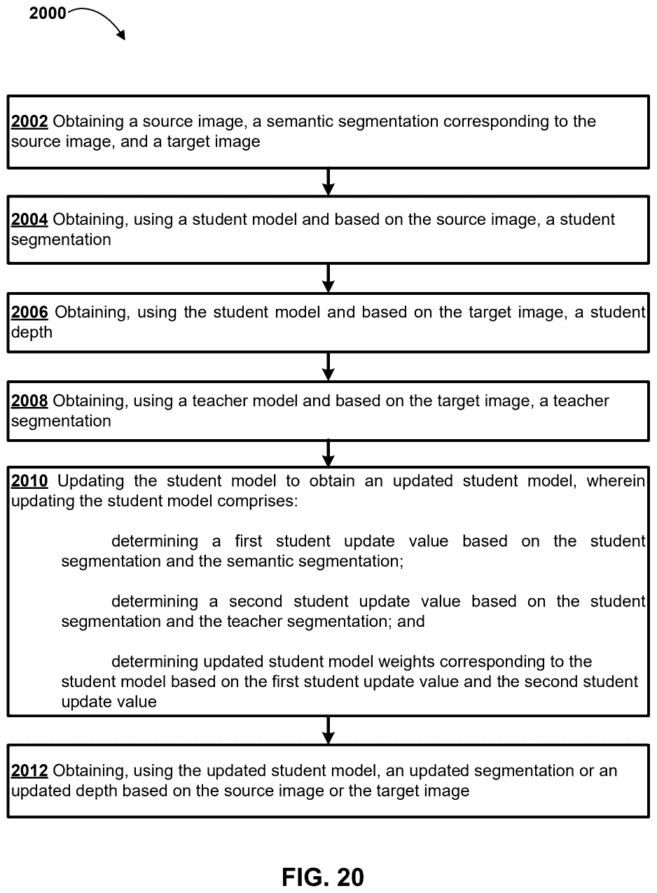

FIG. 20 depicts a flowchart diagram illustrating method 2000, in accordance with example embodiments. In some embodiments, method 2000 may be performed by a system (e.g., system 100 shown and described with reference to FIG. 1, system 800 shown and described in reference to FIG. 8).

At block 2002, method 2000 may include obtaining a source image, a semantic segmentation corresponding to the source image, and a target image.

At block 2004, method 2000 may include obtaining, using a student model and based on the source image, a student segmentation.

At block 2006, method 2000 may include obtaining, using the student model and based on the target image, a student depth.

At block 2008, method 2000 may include obtaining, using a teacher model and based on the target image, a teacher segmentation.

At block 2010, method 2000 may include updating the student model to obtain an updated student model, wherein updating the student model comprises: determining a first student update value based on the student segmentation and the semantic segmentation; determining a second student update value based on the student segmentation and the teacher segmentation; and determining updated student model weights corresponding to the student model based on the first student update value and the second student update value.

At block 2012, method 2000 may include obtaining, using the updated student model, an updated segmentation or an updated depth based on the source image or the target image.

In some embodiments, the student model may include a student feature extractor, a student depth decoder, and a student segmentation decoder. In some embodiments, the student depth decoder may generate the student depth based on a student intermediate output obtained from the student feature extractor. In some embodiments, the student segmentation decoder may generate the student segmentation based on the student intermediate output obtained from the student feature extractor. In some embodiments, the teacher model may include a teacher feature extractor and a teacher depth decoder or a teacher segmentation decoder. In some embodiments, the teacher model may generate the teacher segmentation based on a teacher intermediate output obtained from the teacher feature extractor.

In some embodiments, updating the student model may further include determining a third student update value based on the student depth and a pseudo-depth determined by a pre-trained depth model based on the target image. In some embodiments, determining the updated student model weights may be further based on the third student update value.

In some embodiments, method 2000 may further include refining the teacher segmentation to produce a refined teacher segmentation. In some embodiments, refining the teacher segmentation may include applying segmentation masks generated by a pre-trained segmentation model based on the target image.

In some embodiments, the refining of the teacher segmentation may occur in response to the determining of the third student update value.

In some embodiments, the determining of the third student update value may occur in response to the refining of the teacher segmentation.

In some embodiments, the third student update value may be based on scale and shift invariant root mean squared error between the student depth and the pseudo-depth.

In some embodiments, the first student update value may be based on cross-entropy between the student segmentation and the semantic segmentation. In some embodiments, the second student update value may be based on cross-entropy between the student segmentation and the teacher segmentation.

In some embodiments, determining the updated student model weights may be based on a weighted combination of the first student update value and the second student update value.

### Example Non-Transitory Computer-Readable Media

As stated above, example embodiments may include non-transitory computer readable media having stored thereon program instructions that, upon execution by one or more processors of a computing device, cause the computing device to carry out operations.

In some embodiments, the operations may include updating the first teacher model to obtain an updated first teacher model. In some embodiments, updating the first teacher model may include obtaining, using a second student model and based on the source image, a third source segmentation. In some embodiments, updating the first teacher model may also include obtaining, using the first teacher model and based on the target image, a third target segmentation. In some embodiments, updating the first teacher model may further include obtaining, using the second student model and based on the target image, a fourth target segmentation. In some embodiments, updating the first teacher model may additionally include determining a third model update value based on the third source segmentation and the semantic segmentation. In addition, in some embodiments, updating the first teacher model may include determining a fourth model update value based on the third target segmentation and the fourth target segmentation.

In some embodiments, updating the first teacher model may include determining a moving average of the third model update value, the fourth model update value, and weights corresponding to the first teacher model.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information and/or comparison of signals can correspond to circuitry that can be configured to perform the specific logical functions of a herein-described method or technique. Alternatively or additionally, a step or block that represents a processing of information and/or comparison of signals can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A method comprising:
obtaining a source image, a semantic segmentation corresponding to the source image, and a target image;
obtaining, using a first student model and based on the source image, a first source segmentation;
obtaining, using the first student model and based on the target image, a first target segmentation;
updating the first student model to obtain an updated first student model, wherein updating the first student model comprises:
determining a first model update value based on the first source segmentation and the semantic segmentation;
determining a second model update value based on the first target segmentation and a second target segmentation, wherein the second target segmentation is based on the target image and is obtained using a first teacher model; and
determining updated student weights corresponding to the first student model based on the first model update value and the second model update value; and
obtaining, using the updated first student model, an updated segmentation based on the source image or the target image.

2. The method of claim 1, further comprising:
updating the first teacher model to obtain an updated first teacher model, wherein updating the first teacher model comprises:
obtaining, using a second student model and based on the source image, a third source segmentation;
obtaining, using the first teacher model and based on the target image, a third target segmentation;
obtaining, using the second student model and based on the target image, a fourth target segmentation;
determining a third model update value based on the third source segmentation and the semantic segmentation;
determining a fourth model update value based on the third target segmentation and the fourth target segmentation; and
determining updated teacher weights corresponding to the first teacher model based on the third model update value and the fourth model update value.

3. The method of claim 2, wherein updating the first teacher model further comprises:
determining a moving average of the third model update value, the fourth model update value, and weights corresponding to the first teacher model.

4. The method of claim 2, wherein the first student model comprises a convolutional neural network, and wherein the first teacher model and the second student model each comprise a respective transformer model.

5. The method of claim 1, wherein the first model update value is based on cross-entropy between the first source segmentation and the semantic segmentation, and wherein the second model update value is based on at least one of cross-entropy or Kullback-Leibler Divergence between the first target segmentation and the second target segmentation.

6. The method of claim 1, wherein the second model update value is further based on a similarity between the first target segmentation and the second target segmentation.

7. The method of claim 1, wherein the second model update value is further based on an inconsistency between prediction results in the first target segmentation and prediction results in the second target segmentation.

8. The method of claim 1, wherein determining the updated student weights is based on a weighted combination of the first model update value and the second model update value.

9. A method comprising:
obtaining a source image, a semantic segmentation corresponding to the source image, and a target image;
obtaining, using a student model and based on the source image, a student segmentation;
obtaining, using the student model and based on the target image, a student depth;
obtaining, using a teacher model and based on the target image, a teacher segmentation;
updating the student model to obtain an updated student model, wherein updating the student model comprises:
determining a first student update value based on the student segmentation and the semantic segmentation;
determining a second student update value based on the student segmentation and the teacher segmentation; and
determining updated student model weights corresponding to the student model based on the first student update value and the second student update value; and
obtaining, using the updated student model, an updated segmentation or an updated depth based on the source image or the target image.

10. The method of claim 9, wherein the student model comprises a student feature extractor, a student depth decoder, and a student segmentation decoder, wherein the student depth decoder generates the student depth based on a student intermediate output obtained from the student feature extractor, wherein the student segmentation decoder generates the student segmentation based on the student intermediate output obtained from the student feature extractor, wherein the teacher model comprises a teacher feature extractor and a teacher depth decoder or a teacher segmentation decoder, wherein the teacher model generates the teacher segmentation based on a teacher intermediate output obtained from the teacher feature extractor.

11. The method of claim 9, wherein updating the student model further comprises:
determining a third student update value based on the student depth and a pseudo-depth determined by a pre-trained depth model based on the target image, wherein determining the updated student model weights is further based on the third student update value.

12. The method of claim 11, further comprising:
refining the teacher segmentation to produce a refined teacher segmentation, wherein refining the teacher segmentation comprises applying segmentation masks generated by a pre-trained segmentation model based on the target image.

13. The method of claim 12, wherein the refining of the teacher segmentation occurs in response to the determining of the third student update value.

14. The method of claim 12, wherein the determining of the third student update value occurs in response to the refining of the teacher segmentation.

15. The method of claim 11, wherein the third student update value is based on scale and shift invariant root mean squared error between the student depth and the pseudo-depth.

16. The method of claim 9, wherein the first student update value is based on cross-entropy between the student segmentation and the semantic segmentation, wherein the second student update value is based on cross-entropy between the student segmentation and the teacher segmentation.

17. The method of claim 9, wherein determining the updated student model weights is based on a weighted combination of the first student update value and the second student update value.

18. A non-transitory computer-readable medium having stored thereon program instructions that, upon execution by one or more processors of a computing device, cause the computing device to carry out operations comprising:
obtaining a source image, a semantic segmentation corresponding to the source image, and a target image;
obtaining, using a first student model and based on the source image, a first source segmentation;
obtaining, using the first student model and based on the target image, a first target segmentation;
updating the first student model to obtain an updated first student model, wherein updating the first student model comprises:
determining a first model update value based on the first source segmentation and the semantic segmentation;
determining a second model update value based on the first target segmentation and a second target segmentation, wherein the second target segmentation is based on the target image and is obtained using a first teacher model; and
determining updated student weights based on the first model update value and the second model update value; and
obtaining, using the updated first student model, an updated segmentation based on the source image or the target image.

19. The non-transitory computer-readable medium of claim 18, wherein the operations further comprise:
updating the first teacher model to obtain an updated first teacher model, wherein updating the first teacher model comprises:
obtaining, using a second student model and based on the source image, a third source segmentation;
obtaining, using the first teacher model and based on the target image, a third target segmentation;
obtaining, using the second student model and based on the target image, a fourth target segmentation;
determining a third model update value based on the third source segmentation and the semantic segmentation; and
determining a fourth model update value based on the third target segmentation and the fourth target segmentation.

20. The non-transitory computer-readable medium of claim 19, wherein updating the first teacher model further comprises:
determining a moving average of the third model update value, the fourth model update value, and weights corresponding to the first teacher model.
